(19) United States
(12) Patent Application Publication
(10) Pub. No.: US 2018/0316730 A1
(43) Pub. Date: Nov. 1, 2018

(54) SECURITY MECHANISM FOR COMMUNICATION NETWORK INCLUDING VIRTUAL NETWORK FUNCTIONS

(71) Applicant: NOKIA SOLUTIONS AND NETWORKS OY, Espoo (FI)

(72) Inventors: Manfred SCHAEFER, Forstinning (DE); Jing PING, Chengdu (CN); Stephane MAHIEU, Munich (DE)

(21) Appl. No.: 15/770,247

(22) PCT Filed: Oct. 22, 2015
(86) PCT No.: PCT/EP2015/074434

§ 371 Date: Apr. 23, 2018

(51) Int. Cl. H04L 29/06; H04L 12/24

(52) U.S. Cl. CPC H04L 63/20; H04L 67/10; H04L 41/0803

(57) ABSTRACT

An apparatus comprising at least one processing circuitry, and at least one memory for storing instructions to be executed by the processing circuitry, wherein the at least one memory and the instructions are configured to, with the at least one processing circuitry, cause the apparatus at least: to design an extended security zone configuration for a network service to be instantiated including at least one virtual network function in a communication network comprising virtualized network parts, wherein the extended security zone configuration assigns the at least one virtual network function according to local and/or global security requirements to at least one dedicated security zone, and to provide a security zone descriptor information element describing a final result of the extended security zone configuration design for usage in an information set defining a deployment variant of the network service to be instantiated

### BACKGROUND

### Field

The present invention relates to apparatuses, methods, systems, computer programs, computer program products and computer-readable media usable for providing security in a communication network including virtual network parts.

### Background Art

The following description of background art may include insights, discoveries, understandings or disclosures, or associations, together with disclosures not known to the relevant prior art, to at least some examples of embodiments of the present invention but provided by the invention. Some of such contributions of the invention may be specifically pointed out below, whereas other of such contributions of the invention will be apparent from the related context.

The following meanings for the abbreviations used in this specification apply:
3GPP 3^{rd} Generation Partner Project
ACK: acknowledgment
AP: access point
API: application programming interface
BS: base station
BSS: business support system
CPU: central processing unit
DMZ: demilitarized zone
DOS: denial of service
DSL: digital subscriber line
E2E: endpoint-to-endpoint
EM: element manager
eNB: evolved node B
ETSI European Telecommunications Standards Institute
GUI: graphical user interface
HW: hardware
ID: identification, identifier
IMS: IP multimedia system
IP Internet protocol
KPI: key performance indicator
LSZ: logical security zone
LSZD: logical security zone descriptor
LTE: Long Term Evolution
LTE-A: LTE Advanced
M2M: machine to machine
MANO: management and orchestration
NE: network element
NF: network function
NFV: network function virtualization
NVFI: NVF infrastructure
NFVO: NFV orchestrator
NS: network service
NSD: network service descriptor
NSR: network service record
OS: operation system
OSS: operation support system
PKI: public key infrastructure
PNF: physical network function
PSF: physical security function
PSFR: physical security function record
PSZ: physical security zone
PSZD: physical security zone descriptor
SB: security baseline
SBD: security baseline descriptor
SBR: security baseline record
SDN software defined networks/networking
SEM: security element manager
SFD: security function descriptor
SFR: security function record
SO: security orchestrator
SP: security policy
SPD: security policy/procedure descriptor
SPR: security policy/procedure record
SR: security rule
SRD: security rule descriptor
SRR: security rule record
SS: security service
SSD: security service descriptor
SSR: security service record
ST: service tool
SW: software
SZ: security zone
SZD: security zone descriptor
TPM: trusted platform module
UE: user equipment
UMTS: universal mobile telecommunication system
VIM: virtual infrastructure manager
VM: virtual machine
VNF: virtual network function
VNFC: virtual network function component
VNFD: virtual network function descriptor
VNFM: virtual network function manager
VSF: virtual security function
VSFC: virtual security function component
VSFM: virtual security function manager
VSFR: virtual security function record

Embodiments of the present invention are related to a communication network comprising at least one virtualized network function, virtualized communication function or communication application wherein physical resources and/or at least one physical network function or communication function may be included. A virtualized network function, communication function or communication application may be of any type, such as a virtual core network function, a virtual access network function, a virtual IMS element, a virtualized terminal function, a function or element capable to an M2M communication, or the like.

### SUMMARY

According to an example of an embodiment, there is provided, for example, an apparatus comprising at least one processing circuitry, and at least one memory for storing instructions to be executed by the processing circuitry, wherein the at least one memory and the instructions are configured to, with the at least one processing circuitry, cause the apparatus at least: to design an extended security zone configuration for a network service to be instantiated including at least one virtual network function in a communication network comprising virtualized network parts, wherein the extended security zone configuration assigns the at least one virtual network function according to at least one of local and global security requirements to at least one dedicated security zone, and to provide a security zone descriptor information element describing a final result of the extended security zone configuration design for usage in an information set defining a deployment variant of the network service to be instantiated.

Furthermore, according to an example of an embodiment, there is provided, for example, a method comprising designing an extended security zone configuration for a network service to be instantiated including at least one virtual network function in a communication network comprising virtualized network parts, wherein the extended security zone configuration assigns the at least one virtual network function according to at least one of local and global security requirements to at least one dedicated security zone, and providing a security zone descriptor information element describing a final result of the extended security zone configuration design for usage in an information set defining a deployment variant of the network service to be instantiated.

Moreover, according to an example of an embodiment, there is provided, for example, a computer program product, comprising a computer usable medium having a computer readable program code embodied therein, the computer readable program code adapted to execute a process comprising designing an extended security zone configuration for a network service to be instantiated including at least one virtual network function in a communication network comprising virtualized network parts, wherein the extended security zone configuration assigns the at least one virtual network function according to at least one of local and global security requirements to at least one dedicated security zone, and providing a security zone descriptor information element describing a final result of the extended security zone configuration design for usage in an information set defining a deployment variant of the network service to be instantiated.

According to further refinements, these examples may include one or more of the following features:
configuration information and an default information set defining a deployment variant of the network service to be instantiated may be acquired, a security zone policy using the configuration information may be defined, the at least one virtual network function may be assigned to at least one of a physical security zone and a logical security zone, wherein the physical security zone is set on a at least one dedicated host hardware of the communication network, and the logical security zone is set on one physical security zone, and security attributes for the at least one virtual network function may be determined;
the configuration information may include at least one of a virtual network function descriptor information indicating security related requirements and a security zone profile information indicating organization policies, wherein the at least one virtual network function may be assigned to at least one of the physical security zone and the logical security zone by segmenting the at least one virtual network function to at least one of the physical security zone and the logical security zone on the basis of the virtual network function descriptor information and the security zone profile information;
the virtual network function descriptor information may define vendor-specific security related requirements including a requirement for support of security related hardware, and the security zone profile information may define security zone related policies based on at least one of organization policies, standards, regional regulations, legal requirements, and includes at least one of a vendor separation indication, a tenant separation indication, and redundancy information;
an editing procedure for altering and refining an design result of an default extended security zone configuration according to a user input may be conducted, wherein the editing procedure may be conducted by using a user interface including at least one of a graphical user interface, a text based editing tool and a script based editing tool, and may provide the ability to overrule settings provided by configuration information used in the design of the default extended security zone configuration;
for providing the security zone descriptor information element describing the final result of the extended security zone configuration design for usage in the information set defining the deployment variant of the network service to be instantiated, at least one of a physical security zone descriptor indicating an assignment of the at least one virtual network element to a physical security zone, a logical security zone descriptor indicating an assignment of the at least one virtual network function to a logical security zone, and a security attribute information according to the final extended security zone configuration may be provided;
the security attribute information may include at least one of resource allocation relevant attributes indicating at least one of a location of a hardware of the communication network where the at least one virtual network function is to be instantiated, an exclusion of a specified location or setting for the at least one virtual network function to be instantiated, a capability of a hardware of the communication network where the at least one virtual network function is to be instantiated, a type of a cloud where the at least one virtual network function is to be instantiated, and a requirement for a security related hardware, and resource allocation independent attributes indicating at least one of a requirement for vendor separation, a requirement for tenant separation, and a redundancy requirement;
a successful establishment of security zones in the communication network may be validated after providing the security zone descriptor information element describing the final result of the extended security zone configuration design;
an information indicating the creation of the network service to be instantiated may be received, it may be validated that a security zone policy is fulfilled in the creation of the network service for validating a successful establishment of security zones in the communication network, and a result of the validation may be informed;
the information set defining the deployment variant of the network service to be instantiated may be a network service descriptor;
the above defined processing may be implemented in a security orchestrator element or function managing security in the communication network.

According to an example of an embodiment, there is provided, for example, an apparatus comprising at least one processing circuitry, and at least one memory for storing instructions to be executed by the processing circuitry, wherein the at least one memory and the instructions are configured to, with the at least one processing circuitry, cause the apparatus at least: to obtain an information set defining a deployment variant of a network service to be instantiated in a communication network comprising virtualized network parts, the network service including at least one virtual network function, to determine whether the information set includes a security zone descriptor information element describing an extended security zone configuration assigning the at least one virtual network function according to at least one of global and local security requirements to at least one dedicated security zone, and to create the network service in the communication network according to the information set wherein the at least one dedicated security zone is built by selecting required resources in the communication network according to information of the security zone descriptor information element.

Furthermore, according to an example of an embodiment, there is provided, for example, a method comprising obtaining an information set defining a deployment variant of a network service to be instantiated in a communication network comprising virtualized network parts, the network service including at least one virtual network function, determining whether the information set includes a security zone descriptor information element describing an extended security zone configuration assigning the at least one virtual network function according to at least one of local and global security requirements to at least one dedicated security zone, and creating the network service in the communication network according to the information set wherein the at least one dedicated security zone is built by selecting required resources in the communication network according to information of the security zone descriptor information element.

Moreover, according to an example of an embodiment, there is provided, for example, a computer program product, comprising a computer usable medium having a computer readable program code embodied therein, the computer readable program code adapted to execute a process comprising obtaining an information set defining a deployment variant of a network service to be instantiated in a communication network comprising virtualized network parts, the network service including at least one virtual network function, determining whether the information set includes a security zone descriptor information element describing an extended security zone configuration assigning the at least one virtual network function according to at least one of local and global security requirements to at least one dedicated security zone, and creating the network service in the communication network according to the information set wherein the at least one dedicated security zone is built by selecting required resources in the communication network according to information of the security zone descriptor information element.

According to further refinements, these examples may include one or more of the following features:
the at least one dedicated security zone may be built by deploying and configuring the at least one virtual network function according to information of the security zone descriptor information element by using a virtual network function managing element or function in the communication network;
the dedicated security zone may comprise at least one of a physical security zone and a logical security zone to which the at least one virtual network function is assigned, wherein the physical security zone may be set on at least one dedicated host hardware of the communication network, and the logical security zone is set on one physical security zone;
the security zone descriptor information element describing the extended security zone configuration may include at least one of a physical security zone descriptor indicating an assignment of the at least one virtual network element to a physical security zone, a logical security zone descriptor indicating an assignment of the at least one virtual network function to a logical security zone, and a security attribute information according to the final extended security zone configuration;
the security attribute information may include at least one of resource allocation relevant attributes indicating at least one of a location of a hardware of the communication network where the at least one virtual network function is to be instantiated, an exclusion of a specified location or setting for the at least one virtual network function to be instantiated, a capability of a hardware of the communication network where the at least one virtual network function is to be instantiated, a type of a cloud where the at least one virtual network function is to be instantiated, and a requirement for a security related hardware, and resource allocation independent attributes indicating at least one of a requirement for vendor separation, a requirement for tenant separation, and a redundancy requirement;
a procedure for a validation of a successful establishment of security zones in the communication network after creating the network service may be conducted, and, in case the successful establishment of the security zones is validated, connectivity in the network service may be built;
an information indicating the creation of the network service to be instantiated may be provided, an information may be received indicating a result of a validation that a security zone policy is fulfilled in the creation of the network service for validating a successful establishment of security zones in the communication network;
the information set defining the deployment variant of the network service to be instantiated may be a network service descriptor;
the above described processing may be implemented in a network function virtualization orchestrator element or function managing virtualized network parts in the communication network.

In addition, according to embodiments, there is provided, for example, a computer program product for a computer, including software code portions for performing the steps of the above defined methods, when said product is run on the computer. The computer program product may include a computer-readable medium on which said software code portions are stored. Furthermore, the computer program product may be directly loadable into the internal memory of the computer and/or transmittable via a network by means of at least one of upload, download and push procedures.

### BRIEF DESCRIPTION OF THE DRAWINGS

Some embodiments of the present invention are described below, by way of example only, with reference to the accompanying drawings, in which:

FIG. 1 shows a diagram illustrating a general architecture of a communication network where some examples of embodiments are implementable;

FIG. 2 shows a diagram illustrating a reference architecture of a management and orchestration system for network function virtualization in a communication network according to some examples of embodiments;

FIGS. 3A to 3E show diagrams illustrating examples of security zone configurations according to some examples of embodiments;

FIG. 4 shows a flow chart illustrating a procedure for defining an extended security zone configuration according to some examples of embodiments;

FIG. 5 shows a workflow diagram illustrating an a processing for preparing and designing security according to some examples of embodiments;

FIGS. 6A and 6B show diagrams illustrating a result of security policy definition according to some examples of embodiments;

FIGS. 7A and 7b show flow chart illustrating a procedure for deploying a security zone policy for a network service according to some examples of embodiments;

FIG. 8 shows a flow chart illustrating a procedure for validating a security zone policy for a network service according to some examples of embodiments;

FIG. 9 shows a workflow diagram illustrating a processing for deploying network security according to some examples of embodiments;

FIG. 10 shows a workflow diagram illustrating a processing for deploying network security according to some examples of embodiments;

FIG. 11 shows a workflow diagram illustrating a processing for deploying network security according to some examples of embodiments;

FIG. 12 shows a flow chart of a processing conducted in a security orchestrator element or function according to some examples of embodiments; and

FIG. 13 shows a flow chart of a processing conducted in a network function virtualization orchestrator element or function according to some examples of embodiments;

FIG. 14 shows a diagram of a network element or function acting as a security orchestrator according to some examples of embodiments; and

FIG. 15 shows a diagram of a network element or function acting as a network function virtualization orchestrator according to some examples of embodiments.

### DESCRIPTION OF EMBODIMENTS

In the last years, an increasing extension of communication networks, e.g. of wire based communication networks, such as the Integrated Services Digital Network (ISDN), DSL, or wireless communication networks, such as the cdma2000 (code division multiple access) system, cellular 3rd generation (3G) like the Universal Mobile Telecommunications System (UMTS), fourth generation (4G) communication networks or enhanced communication networks based e.g. on LTE or LTE-A, fifth generation (5G) communication networks, cellular 2nd generation (2G) communication networks like the Global System for Mobile communications (GSM), the General Packet Radio System (GPRS), the Enhanced Data Rates for Global Evolution (EDGE), or other wireless communication system, such as the Wireless Local Area Network (WLAN), Bluetooth or Worldwide Interoperability for Microwave Access (WiMAX), took place all over the world. Various organizations, such as the European Telecommunications Standards Institute (ETSI), the 3rd Generation Partnership Project (3GPP), Telecoms & Internet converged Services & Protocols for Advanced Networks (TISPAN), the International Telecommunication Union (ITU), 3rd Generation Partnership Project 2 (3GPP2), Internet Engineering Task Force (IETF), the IEEE (Institute of Electrical and Electronics Engineers), the WiMAX Forum and the like are working on standards or specifications for telecommunication network and access environments.

Generally, for properly establishing and handling a communication connection between two end points (e.g. terminal devices such as user equipments (UEs) or other communication network elements, a database, a server, host etc.), one or more network elements such as communication network control elements, for example access network elements like access points, base stations, eNBs etc., and core network elements or functions, for example control nodes, support nodes, service nodes, gateways etc., are involved, which may belong to different communication network systems.

Such communication networks comprise, for example, a large variety of proprietary hardware appliances. Launching a new network service often requires yet another appliance and finding the space and power to accommodate these boxes is becoming increasingly difficult. Moreover, hardware-based appliances rapidly reach end of life. Due to this, it has been considered to use, instead of hardware based network elements, virtually generated network functions, which is also referred to as network functions virtualization. By means of software based virtualization technology, it is possible to consolidate many network equipment types onto industry standard high volume servers, switches and storage, which could be located in data centers, network nodes and in the end user premises, for example.

In the recent years, the virtualization of telecommunication network elements and running them on a standard Commercial of the Shelf HW platforms such as clouds has evolved. These virtualized network elements are then called VNF and are configured to run, for example, in telecommunication clouds. One example for a frame of such a telecommunication cloud is provided, for example, by ETSI NFV. For the sake of simplicity, network function virtualization will be referred to in the following as NFV.

However, instead of separated physical network elements in former network architecture, replacement of these elements by network function virtualization also causes that such a physical separation is not valid any time, since VNFs may run on one and the same HW. As such, it is necessary to consider also a logical separation of VNFs, in order to ensure the security of virtualized telecommunication networks.

It is to be noted that in a communication system both of a physical and a virtual network element approach may be used simultaneously and in a mixed manner, which is also referred to as a hybrid communication network (referred to hereinafter as “hybrid network”), where virtual and physical nodes, elements, functions etc. coexist and form a (dynamic) network structure. For example, a core network being employed for services comprises virtual and physical network elements or functions interacting which each other. Furthermore, also other network functions besides those of a (core) network (like EPC or IMS), such as network functions of an access network element like an eNB or BS, may be provided as virtual network functions.

NFV involves the implementation of network functions in software that can run on server hardware, such as standard or default server hardware, and that can be moved to, or instantiated/setup in, various locations in the network or cloud/datacenters as required, without the need for installation of new equipment. It is to be noted that NFV is able to support SDN by providing the infrastructure upon which the SDN software can be run.

Furthermore, NFV aligns closely with the SDN objectives to use commodity servers and switches. The SDN-User Plane part may be placed outside or inside the cloud.

As indicated above, NFV is intended to be implemented in such a manner that network functions are instantiated and located within a so-called cloud environment, i.e. a storage and processing area shared by plural users, for example. By means of this, it is for example possible to dynamically placing elements/functions of a core network in a flexible manner into the cloud.

Dynamically placing the NF into the cloud allows also that all of the NFs or some parts or functions of the core network are dynamically withdrawn completely from the cloud (i.e. de-instantiated), while other parts (legacy or SDN based or virtualized network functions) remain in the network structure as deemed necessary.

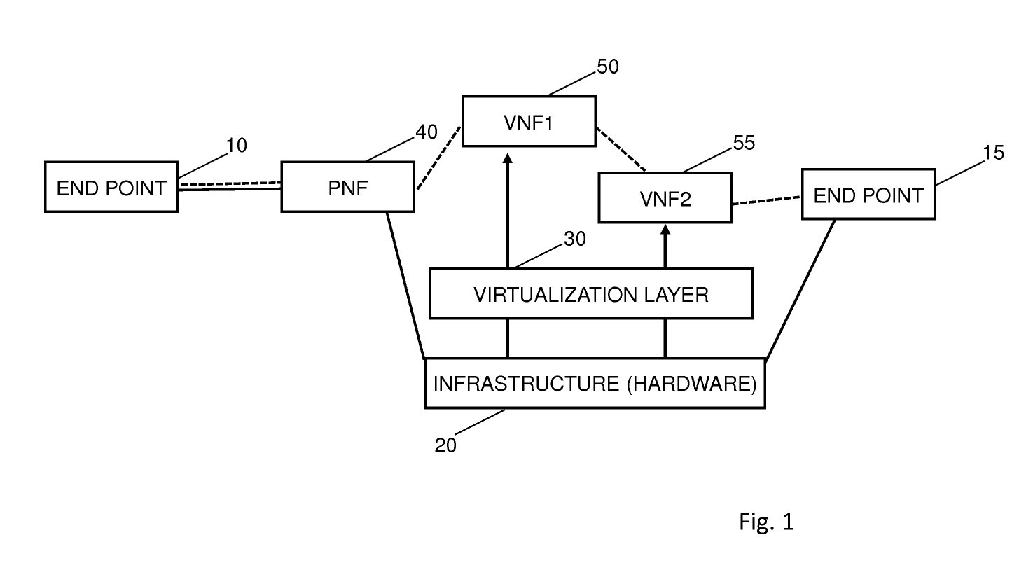

It is to be noted that instantiated (or instantiation) means in the context of the following description, for example, that a virtual network function acting in a communication network in the virtual network part (see e.g. FIG. 1) is set up, turned on, activated or made in some other manner available for other communication network elements or functions. On the other hand, de-instantiated (or de-instantiation) means, for example, that a virtual network function acting in a communication network in the virtualized network part (see e.g. FIG. 1) is turned off, deactivated or made in some other manner not available for other communication network elements or functions, i.e. the instantiation of the virtual network function in question is removed or cancelled, at least temporarily.

There are various approaches for configuring a virtualized communication network running in a cloud environment. As one example, the Management and Orchestration (MANO) working group inside the ETSI Network Function Virtualization (NFV) Industry Specification Group (ISG) has developed a telecommunication cloud concept which is also referred to as ETSI NFV Reference Architecture. There have been defined so-called management entities such as a NFV Orchestrator (NVFO), VNF Manager (VNFM) etc. which are used to deploy and manage a virtualized communication network running on a NFV infrastructure.

However, as indicated above, one important aspect in the field of networks and in particular communication networks is that also security services and functions have to be deployed and managed. Security concerns, for example, communication security, credential management and provisioning, trust management, hardening, etc.

Virtualized telecommunication networks rely on a logical separation of VNFs by means of one of several possible mechanisms for virtualization, such as by a virtualization layer employing e.g. a network element like a hypervisor (described later), by container based technology. However, security capabilities including e.g. isolation and resource management principles may be weakened by the dynamic, shared and distributed architecture of the cloud. This may lead to the case that the logical separation is broken. This may severely impact the security of a virtualized telecommunication network. For example, when a VNF or VM is compromised by an attacker, it is possible to perform nearly all kinds of attacks against availability, integrity and confidentiality. For instance, DoS attacks could be performed e.g. by simply deleting other VNFs/VMs running on the same host HW (meaning running e.g. on the same hypervisor). Furthermore, the integrity as well as the confidentiality of traffic could be impaired by either changing or eavesdropping the traffic. Furthermore, it is sometimes not possible to fulfil security requirements or security related requirements, e.g. requirements pertaining to trust level of the platform (e.g. trusted boot) during deployment of the VNFs. Also security or security related requirements pertaining to platform capabilities (consider hardware, NFVI etc., e.g. Hardware Security Module (HSM), PKI interfaces (for example when platforms entitled or not entitled to interface with PKI are to be included) etc.) may be not fulfilled during deploying the VNFs. Moreover, the localization of a VNF cannot be guaranteed and attested which may cause security and jurisdiction problem.

In this context, it is to be noted that the availability of credential/key material and/or PKI capabilities and interfaces can also be a security requirement for a security zone. For instance, not every HW platform may be allowed to act as PKI entity (like e.g., RA) and to create keys (securely) and/or to acquire certificates for the VNF on top. Also trustworthiness of the platform (VNF manager) to manage secret key material may be important.

This concerns, for example, the requirement to isolate a Home Subscriber Server (HSS) which has sensitive data from user and other NF like Call Session Control Function (CSCF), Telecom Application Server (TAS), etc., or the location of PoI (Point of Interception)/PoR (Point of Retention) in case of Lawful Interception, or in case a high trust level is required for a control plane node like a Mobility Management Entity (MME), etc.

There are so-called affinity and anti-affinity rules. By means of these, it is possible to influence the placement of VNFs. However, affinity/anti-affinity rules are designed for reliability purposes in order to avoid that two redundant VNFs run on the same host HW and suffer therefore from a single point of failure, while security aspects are not considered.

Examples of embodiments of the present invention are related to a security concept or mechanism allowing to increase the security level of virtualized telecommunication networks while the impact of attacks can be diminished. Specifically, according to examples of embodiments of the invention, VNFs are assigned to dedicated security zones according to at least one of local or global security requirements, such as internal or VNF related security requirements, external or higher order related security requirements (country specific, law specific, privacy related, organization related etc.), network service related security requirements and so on. For this purpose, methods and instructions for the placement of VNFs are provided aiming to increase the isolation between VNFs of different security zones.

Basically, according to examples of embodiments, a security concept or mechanism is provided which enables for a communication network comprising virtualized network elements or functions, such as a hybrid network, a holistic end-to-end security overview and provides an automated deployment/management of security services/functions inside the communication network. For example, according to some examples of embodiments, a management entity is provided which is applicable to a communication network including virtualized network elements or functions, which may correspond, for example, to the ETSI NFV reference architecture indicated above. That is, an automated security management for a hybrid network considering security in the virtual parts of the hybrid network is provided. According to examples of embodiments, a security service including one or more security (physical and/or virtual) functions is deployed and/or configured and/or managed wherein security requirements for the network provided by security policies are realized by the security service and the security function(s).

Embodiments as well as principles described below are applicable in connection with any (physical or virtual) network element or function being included in a (hybrid) communication network environment including at least one virtualized network element or function, such as a terminal device, a network element, a relay node, a server, a node, a corresponding component, and/or any other element or function of a communication system or any combination of different communication systems that support required functionalities. The communication system may be any one or any combination of a fixed communication system, a wireless communication system or a communication system utilizing both fixed networks and wireless parts. The protocols used, the specifications of networks or communication systems, apparatuses, such as nodes, servers and user terminals, especially in wireless communication, develop rapidly. Such development may require extra changes to an embodiment. Therefore, all words and expressions should be interpreted broadly and they are intended to illustrate, not to restrict, embodiments.

In the following, different exemplifying embodiments will be described using, as an example of a communication network to which the embodiments may be applied, a radio access architecture based on 3GPP standards, such as a third generation or fourth generation (like LTE or LTE-A) communication network, without restricting the embodiments to such architectures, however. It is obvious for a person skilled in the art that the embodiments may also be applied to other kinds of communication networks having suitable means by adjusting parameters and procedures appropriately, e.g. WiFi, worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs), wired access, etc.

The following examples and embodiments are to be understood only as illustrative examples. Although the specification may refer to “an”, “one”, or “some” example(s) or embodiment(s) in several locations, this does not necessarily mean that each such reference is related to the same example(s) or embodiment(s), or that the feature only applies to a single example or embodiment. Single features of different embodiments may also be combined to provide other embodiments. Furthermore, terms like “comprising” and “including” should be understood as not limiting the described embodiments to consist of only those features that have been mentioned; such examples and embodiments may also contain features, structures, units, modules etc. that have not been specifically mentioned.

A basic system architecture of a telecommunication network comprising virtualized network elements or functions and including a communication system where some examples of embodiments are applicable may include an architecture of one or more communication networks including a wired or wireless access network subsystem and a core network. Such an architecture may include one or more communication network control elements, access network elements, radio access network elements, access service network gateways or base transceiver stations, such as a base station (BS), an access point (AP) or an eNB, which control a respective coverage area or cell(s) and with which one or more communication elements, user devices or terminal devices, such as a UE, or another device having a similar function, such as a modem chipset, a chip, a module etc., which can also be part of an element, function or application capable of conducting a communication, such as a UE, an element or function usable in a machine-to-machine communication architecture, or attached as a separate element to such an element, function or application capable of conducting a communication, or the like, are capable to communicate via one or more channels for transmitting several types of data. Furthermore, core network elements such as gateway network elements, policy and charging control network elements, mobility management entities, operation and maintenance elements, and the like may be included.

The general functions and interconnections of the described elements, which also depend on the actual network type, are known to those skilled in the art and described in corresponding specifications, so that a detailed description thereof is omitted herein. However, it is to be noted that several additional network elements and signaling links may be employed for a communication to or from an element, function or application, like a communication endpoint, a communication network control element, such as an server, a radio network controller, and other elements of the same or other communication networks besides those described in detail herein below.

A communication network including virtualized network elements or functions as being considered in examples of embodiments may also be able to communicate with other networks, such as a public switched telephone network or the Internet. The communication network may also be able to support the usage of cloud services for the virtual network elements or functions thereof, wherein it is to be noted that the virtual network part of the telecommunication network can also be provided by non-cloud resources, e.g. an internal network or the like. It should be appreciated that network elements of an access system, of a core network etc., and/or respective functionalities may be implemented by using any node, host, server, access node or entity etc. being suitable for such a usage.

Furthermore, a network element, such as communication elements, like a UE, access network elements, like a radio network controller, other network elements, like a server, etc., as well as corresponding functions as described herein, and other elements, functions or applications may be implemented by software, e.g. by a computer program product for a computer, and/or by hardware. For executing their respective functions, correspondingly used devices, nodes, functions or network elements may include several means, modules, units, components, etc. (not shown) which are required for control, processing and/or communication/signaling functionality. Such means, modules, units and components may include, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means including e.g. an antenna unit or the like, means for forming a radio communication part etc.) and the like, wherein respective means forming an interface, such as a radio communication part, can be also located on a remote site (e.g. a radio head or a radio station etc.). It is to be noted that in the present specification processing portions should not be only considered to represent physical portions of one or more processors, but may also be considered as a logical division of the referred processing tasks performed by one or more processors.

It should be appreciated that according to some examples, a so-called “liquid” or flexible network concept may be employed where the operations and functionalities of a network element, a network function, or of another entity of the network, may be performed in different entities or functions, such as in a node, host or server, in a flexible manner. In other words, a “division of labor” between involved network elements, functions or entities may vary case by case.

With regard to FIG. 1, a diagram illustrating a general architecture of a communication network comprising virtualized network elements or functions and including a communication system is shown where some examples of embodiments are implementable. It is to be noted that the structure indicated in FIG. 1 shows only those parts and links which are useful for understanding principles underlying some examples of embodiments of the invention. As also known by those skilled in the art there may be several other network elements or devices involved e.g. in a communication between endpoints in the hybrid network which are omitted here for the sake of simplicity.

It is to be noted that examples of embodiments are not limited to the number of elements, functions, links and applications as indicated in FIG. 1, i.e. there may be implemented or instantiated less of or more of the corresponding elements, functions, applications and links than those shown in FIG. 1.

Reference signs 10 and 15 denote a respective endpoint of a communication connection in the hybrid network. For example, the endpoints 10 and 15 are UEs, servers or any other network element or function between which a communication can be established.

Reference sign 40 denotes a physical network function. For example, the PNF 40 is an access node like an eNB or the like.

Reference signs 50 and 55 represent virtual network functions. For example, VNF1 50 and VNF2 55 are virtual network nodes of a core network of a communication network, such as a gateway, a management element or the like.

Reference sign 20 denotes an infrastructure for virtual network functions. For example, the infrastructure is provided by physical hardware resources comprising computing, storage and networking resources. It represents the totality of hardware and software components which build up the environment in which VNFs are deployed, managed and executed.

Reference sign 30 denotes a virtualization layer which is used to generate, on the basis of the resources provided by the infrastructure 20, virtual instances (i.e. the VNFs 50 and 55, for example). That is, the virtualization layer 30 abstracts the hardware resources and decouples the VNF from the underlying hardware.

The PNF 40, the VNF1 50 and the VNF2 55 form a so-called network service (NS). As indicated by dashes lines, logical links are established between the virtual elements of the hybrid network and between the virtual elements and the physical elements (e.g. the PNF 40 and the endpoint 15). On the other hands, physical links are established between the physical elements of the hybrid network (indicated by solid lines).

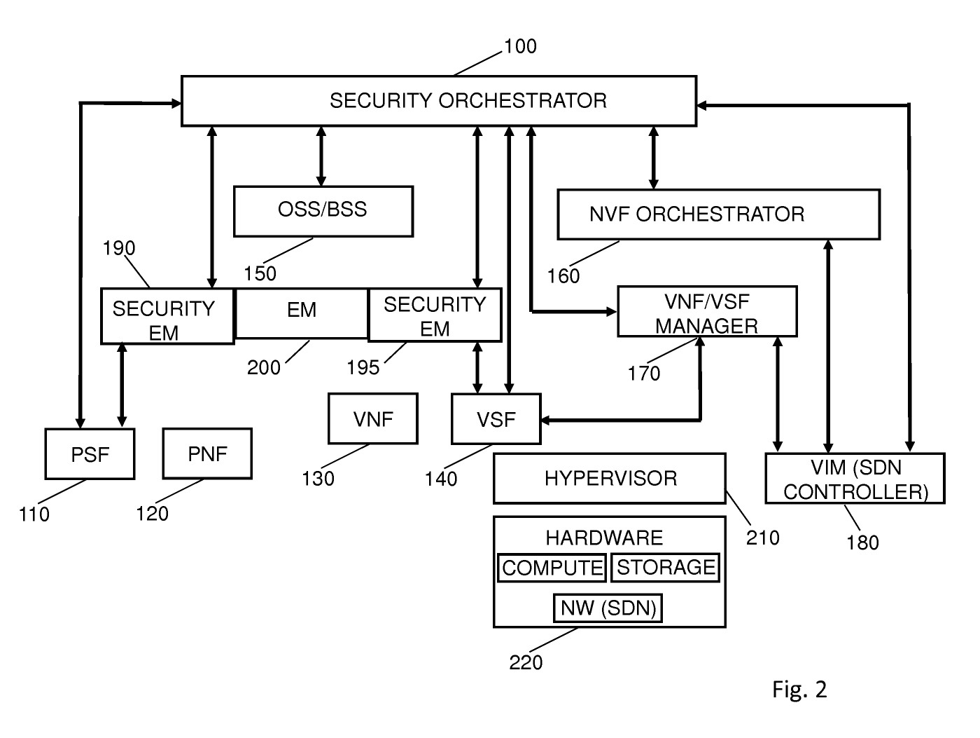

FIG. 2 shows a diagram illustrating a reference architecture of a management and orchestration system for network function virtualization in a communication network according to some examples of embodiments. For example, the reference architecture according to FIG. 2 is related to an ETSI NFV reference architecture as indicated above.

Reference sign 160 denotes a management entity or function like an NFV orchestrator. The NFV orchestrator 160 is used to manage the virtualized network part of the communication network. For example, the NFV orchestrator 160 conducts on-boarding of new network service (NS) and VNFs, wherein the NS is described by a corresponding descriptor file, orchestrated by NFVO, and wherein the NS may cover one or more VNFs and PNFs. Furthermore, NS lifecycle management (including instantiation, scaling, performance measurements, event correlation, termination) is executed. Moreover, a global resource management, validation and authorization of infrastructure resource requests and a policy management for NS instances is conducted. The NFV orchestrator 160 is responsible, for example, for NS automation and comprises a NS catalog, a VNF/VSF catalog, a NFV instances repository and a NVF resources repository for managing the virtualized network part.

Reference sign 150 denotes a management entity or element being responsible for a physical network part of the communication network. For example, the management entity 150 is an OSS/BSS of a network operator of the hybrid network. The OSS/BSS 150 is also responsible for triggering of the NFV orchestrator 160, for example. For example, the OSS/BSS 150 provides service tools like service fulfillment and orchestration.

Reference sign 120 denotes a physical network function (PNF), such as a “real” network element or function acting in the communication network as an instance, e.g. for access network or core network.

Reference sign 110 denotes a physical security function (PSF). For example, the PSF is an entity or element acting for securing a part of the network, such as a firewall or the like, which protects a NF (e.g. PNF 120), or a network service which may also run in the virtual part of the hybrid network.

Reference sign 200 denotes an element manager (EM) performing management functionality for network functions. Reference signs 190 and 195 denote security element managers which may be part of EM 200, a combined entity or function or separate entities or functions. The SEM 190/195 performs, for example, managing functionalities for the PSF 110, a VSF (described below), or both. It is to be noted that the PSF 110 (and/or the VSF) can be controlled either directly or via the SEM 190/195, for example.

Reference sign 170 denotes a management entity or function for managing VNF and/or VSF in the hybrid network. For example, the management entity 170 is a VNF/VSF manager being responsible for VNF/VSF lifecycle management (i.e. instantiation, update, termination) of a VNF/VSF. Also VNF/VSF elasticity management (scaling) and VNF/VSF basic configuration is conducted by the management entity 170. It is to be noted that the VNF/VSF manager 170 may also be provided for managing VNF/VSF of third parties.

Reference sign 180 denotes a management entity or function for controlling and managing interaction of a VNF/VSF with computing, storage and network resources. For example, the management entity 180 is a virtualized infrastructure manager (VIM), which controls and manages the infrastructure compute, storage and network resources within one operator's infrastructure sub-domain. The VIM 180 may also comprise management of virtualization layer-based (e.g hypervisor-based) security features. Moreover, a SDN controller part may be included.

Reference sign 210 denotes a virtualization layer such as a hypervisor (also referred to as virtual machine monitor) which is a piece of computer software, firmware or hardware that creates and runs virtual machines (VM), such as software based or kernel based VMs. It is to be noted that according to some examples of embodiments the hypervisor 210 may provide also security functions which will be discussed below. The hypervisor 210 is manageable via the VIM 180, for example.

The hypervisor 210 is set on hardware 220 (such as a datacenter hardware) providing compute, storage and network (SDN) resources.

Reference sign 130 denotes a virtual network function (VNF), such as a virtualized network function acting in the communication network as an instance, e.g. for access network or core network. For example, according to some examples of embodiments, a VNF may be composed of multiple VNF components (VNFCs, corresponding to VMs) where the architecture is described by a corresponding descriptor file and is instantiated by the VNF manager 170.

Reference sign 140 denotes a virtual security function (VSF). The VSF 140 is a VNF with a security functionality. A VSF may be composed of multiple VSF Components (VSFCs, corresponding to VMs). For example, the VSF is a function acting for securing a part of the hybrid network, such as a virtual firewall or the like, which protects a NF or a NS (e.g. VNF 130). The architecture of a VSF is described by a corresponding descriptor file and will be instantiated by the VNF/VSF manager 170.

Reference sign 100 denotes a management entity or function which is also referred to as security orchestrator (SO). According to examples of embodiments, the SO 100 is configured to perform security-related management tasks inside a communication network comprising virtualized network functions or elements, wherein in the following for illustrative purposes an implementation in an ETSI NFV reference architecture is assumed. However, it is to be noted that examples of embodiments of the invention are not limited to such an implementation example.

According to some examples of embodiments, security orchestration denotes the automation of simple or complex security-related management tasks, for example in a hybrid (i.e. physical plus virtual) telecommunication network environment. That is, orchestration is to be understood as automated execution of one or more management tasks.

As indicated in FIG. 2, the SO 100 comprises a number of interfaces to other management entities inside the reference architecture. Via these interfaces, which will be described in further detail below, the SO 100 is adapted to perform interactions with the connected management entity partners for controlling at least one of deployment/configuration/management of a security service as described in the following.

According to some examples of embodiments of the invention, the SO is able to provide a holistic view on end-to-end security in hybrid networks (see e.g. FIG. 1) and to automate all security-related management tasks such as for example the control of the deployment and the configuration of all security functions in a dynamic hybrid network environment.

When referring to the architecture indicated in FIG. 2, for example, the SO 100 is from a functional point of view on the same level as the OSS/BSS 150 and the NFV orchestrator 160. While the NFV orchestrator 160 is used to manage the virtualized network, the OSS/BSS 150 is responsible for the physical network part and for triggering the NFV orchestrator 160, e.g. in case of instantiation or de-instantiation of network services realized by means of VNFs.

The SO 100, on the other hand, has a complete network view (i.e. physical plus virtualized parts) so as to control deployment of security services, realized by means of SFs, e.g. SFs provided by the hypervisor being accessible via the VIM 180, PSFs and VSFs. According to further examples of embodiments, an additional task of the SO 100 is to configure the security of NFVI resources realized by means of SDN (see also network part of hardware 220, for example) e.g. on the SDN controller (via VIM 180, for example). Furthermore, the SO 100 is responsible for the management and configuration of security function applications in the communication network in order to maintain consistent security policies for a security service realized by means of the SFs. According to examples of embodiments, management/configuration can be done directly by the SO 100 itself (i.e. by directly controlling the PSF/VSF) or alternatively via a corresponding SEM (e.g. SEM 190/195).

According to some examples of embodiments, the SO 100 is configured to automatically and consistently manage all security services, realized e.g. by means of security functions, in the communication network. These are, for example, depending on the communication network structure, one or more of the physical security functions (PSFs), such as SFs of legacy networks (e.g. PSF 110), the virtualized VSF/VM-based security functions or virtual security functions (e.g. VSF 140), and security functions provided in the hypervisor 210 (as indicated, the hypervisor-based SFs are accessible via the VIM 180, e.g. via APIs in the VIM).

It is to be noted that according to some examples of embodiments, the SO 100 configures and manages the virtual and physical security functions which are deployed by the NFVO, for example, and deploys, configures and manages security functions provided by the hypervisor 210 in the hybrid network (via VIM 180, for example).

The topology of the virtualized network is described by means of an information set describing deployment variants of network services to be instantiated or built in the communication network, is provided for example by a so-called Network Service Descriptor (NSD). The NSD consists of information elements which are used by the NFVO, for example, to instantiate the NS which includes one or more of VNFs, PNFs, virtual links and the like. The NSD may also include the Virtual Security Functions. This complete NSD (network topology including security functions) is the result of a cooperation between the network and the security team during the preparation phase. According to the topology description in the NSD the virtualized network is built by the NFV Orchestrator (Network Orchestrator) without involvement of the Security Orchestrator. The NFV Orchestrator integrates the VSFs in the network topology without any knowledge about their security functionality (from its point of view VSFs are just as every other VNFs).

The general construction or building of the VSFs is done by the VNF/VSF manager 170. In other words, a VSF can be also considered as a VNF with security functionality. However, the VNF/VSF manager 170 is not aware of this specific security functionality but builds the VSF out of its VSF components as every other VNF. According to some examples, the VNF/VSF manager 170 conducts at least in part the configuration of VSFs, e.g. enforcement of a VSF in a specific security zone or injection of credentials to enable cryptographical protection. The information about the configuration of the VSF is already contained in the VNF/VSF descriptors (VNFD/VSFD), provided via the NSD to the VNF/VSF manager, e.g. by the NFV orchestrator 160.

VSFs may be provided also by third-party vendors. Therefore, the VNF/VSF manager 170 is also configured to manage virtualized third-party security applications. Alternatively, a specific third-party VSF manager can be provided which works in parallel to the VNF Manager 170 (in FIG. 2, this is not specifically indicated).

The Security Orchestrator has the end-to-end network security view and is therefore responsible to align security policies in an automated way inside of the virtualized network and also between the physical and the virtualized network parts. As virtualized networks are assumed to be highly flexible concerning the placement, the addresses and the number of VNFs being assigned to a specific network service, the security configuration and the security policies have to be adapted to these changing scenarios and have automatically to ensure consistent security policies. This applies for both physical and virtual security function. For example, assuming a physical security function, e.g. in front of a datacenter, like a firewall, which has rather fixed setting, those security functions are nevertheless influenced by the dynamism of the virtualized network part. For example, in case a new network service is created or an old one is removed, not only policies for virtual security functions are changed but also the policies of the physical security function have potentially to be adapted. For example, assuming a case where a network service is created comprising in a virtual part a network function being protected by two virtual firewalls as VSFs, not only the virtual firewalls have to be configured but also a physical firewall protecting, for example, a PNF located in front of the virtual part.

According to some examples of embodiments, the SO 100 executes one or more management tasks (this is also referred to as orchestration, as indicated above). In this context, according to some examples of embodiments, the management tasks include also a mechanism to design so-called extended security zones allowing to increase the security of the communication network including virtualized network elements or functions such as that shown in FIG. 1. The extended security zone concept according to examples of embodiments implies instructions on the placement of VNFs aiming to increase the isolation between VNFs of different security zones. According to some examples, security zones with physical and logical isolation are provided. Physical isolation means that the VNFs/VMs of different security zones will never be placed on the same host HW. Thus, physical separation can also be achieved in a cloud environment. Logical separation means that isolation is additionally increased so that VNFs/VMs of different security zones on the same host HW can (under normal conditions) not see anything from each other (e.g. in case the hypervisor is not compromised). While physical security zoning provides a certain level of security, logical security zones can be applied, for example, depending on a threat and risk analysis. A further aspect of some examples of embodiments is that, besides the separation into different security groups/zones, additional requirements regarding security like for example placement requirements for a specific VNF in a dedicated country or on a dedicated site, cloud type selection parameters as private, public or hybrid cloud, a requirement for usage or support of security related hardware, such as TPM support requirements for trusted boot, availability of general crypto hardware (such as HSM or crypto accelerators), GPS/geo-location identifiers etc. are considered. For this, at least one of local or global security requirements are defined, such as internal or VNF related security requirements, external or higher order related security requirements (country specific, law specific, privacy related, organization related etc.), network service related security requirements and so on. The security attributes can be differentiated in two different groups: the first group is resource-allocation-relevant and has influence on the placement while the second group is resource-allocation-independent, like for example vendor or tenant separation that will be considered for security zoning, redundancy requirement etc. A corresponding information is provided for example as a security zone descriptor included in an information set defining the deployment variants of a network service to be instantiated, such as the NSD.

In addition, according to further examples, the SO 100 may have the following tasks. As one task, a security service central management task is executed which includes also security service lifecycle and initiation of elasticity management. The security service central management is used for managing security based on a security service catalog, a security function catalog, triggering lifecycle management of the security service which includes any one or more of VSFs, PSFs and security functions in the hypervisor, monitoring the status of the security service, collecting performance KPIs of the security services, and making scaling decision based on the KPIs.

Another task is security policy central management/automation. The security policy central management is responsible to configure and maintain consistent end-to-end security policies in the hybrid network, wherein the processing related to the security policy central management is executed in an automated way.

A further task is security baseline management. Security baseline management is responsible to establish a predefined baseline for implementing security, i.e. baseline rules such as for security zoning, traffic separation, traffic protection, storage data protection, virtual security appliances, SW integrity protection, protection of management traffic, wherein in these rules common or specific regulations, standards, guidelines and best practice models for security applications, such as for telecommunication cloud security, are considered. The baseline is generated and stored in advance, for example.

Another task is credential management. For example, in a multi-tenant cloud-based environment (such as a NFV infrastructure), crypto-graphical protection is required for manifold use cases like for example traffic protection, storage data protection, SW integrity protection or protection of management traffic. Thus a central credential management in the SO 100 is provided which manages credential provisioning. Since the SO 100 controls also security in the physical network part, it is possible to provide an overall network-wide credential management. That is, according to some examples of embodiments, credential provisioning for VNFs, PNFs or other hybrid network elements or functions, as well as for entities of the management and orchestration architecture, such as management entities or functions like as NFVO, VNFM, VIM is provided by the credential management task.

A further task is trust management. According to some examples of embodiments, decisions in the hybrid network regarding interactions with other VNF or NFVI entities may depend on the degree of trust into these entities. A potential way to achieve a NFVI-wide trust management is to provide a central trust manager. The central trust manager is part of the SO 100, for example. The central trust manager is configured, for example, to evaluate a trust level (a value or parameter) indicating the trust of relevant VNF and NFVI entities and to provide a result of the evaluation (i.e. the trust level), e.g. on demand. That is, according to some examples of embodiments, trust management for VNFs, PNFs or other hybrid network elements or functions, as well as for entities of the management and orchestration architecture, such as management entities or functions like as NFVO, VNFM, VIM is provided by the trust management task.

As another task, the management of hypervisor security functions is executed. Security functions inside a virtualized network can either be provided as VSFs (a VNF with security functionality) running on top of the hypervisor 210, and/or can be provided inside the hypervisor itself (as part of the NFV infrastructure). According to some examples of embodiments, the NFV infrastructure may be operated by a legally independent NFV infrastructure provider. In this case, it is not reasonable to directly configure them by the SO 100. Therefore, the hypervisor-based security functions are accessible via the VIM 180 (as indicated above) as security features to be configured by means of APIs, for example. Security features in the context of the hypervisor security functions are for example the provisioning of virtual firewalls. Virtual firewalls can be provided in the hypervisor as well as in form of VSFs on top of the hypervisor.

A further task is hardening security status. Hardening security status provides the actual patch status of VNFs/VSFs including guest OS as well as of important NFV infrastructure components (for example the hypervisor). According to some examples of embodiments, also an automated patch provisioning and patching processing may be supported.

Moreover, as a further task, according to some examples of embodiments, a management task is used for provisioning and assignment of VNFs/VSFs to security zones, i.e. to design the extended security zone configuration as described above. This may be conducted by means of a specific task or as a sub-task of one of the previously described tasks. According to examples of embodiments, the establishment and enforcement of security zones is executed by using a suitable interface between elements being involved.

It is to be noted that the security measures described above can be summarized hereinafter as a “security of communication” which is to be understood in the context of examples of embodiments of the invention in a broad sense and comprises at least one of the described security measures and/or other security measures not explicitly described herein.

As indicated above, there are several interfaces provided which allow the SO 100 to interact with other management entities (both for the physical part and the virtual part of the hybrid network) in the reference architecture for performing the holistic security orchestrator tasks. In the following, these interfaces are described in further detail.

As indicated in FIG. 2, there are interfaces (indicated by arrows) towards the PSF 110, the VSF 140 or towards SEM 190/195 managing a PSF and/or a VSFs. That is, the PSFs/VSFs can be either managed by the SO 100 directly or indirectly via a (potentially third-party) SEM. In this context, it is to be noted that according to some examples of embodiments a SEM is configured can manage both of the PSFs and VSFs for the same vendor. Multiple SEMs to manage the PSFs/VSFs of different security vendors are also possible.

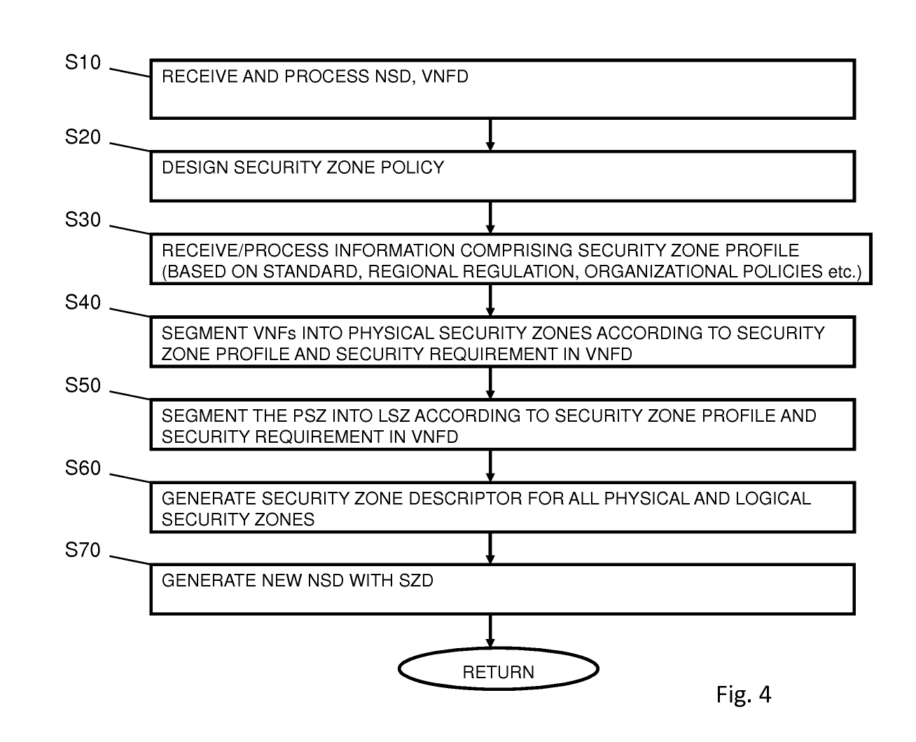

A further interface is provided towards the OSS/BSS 150 which provides e.g. service tools like service fulfillment/orchestration. This interface provides management access to the physical part of the (hybrid) communication network. For example, according to some examples of embodiments, the interface towards OSS/BSS 150 is required during a preparation phase for creating the complete NSD (including security) (see also FIG. 4). Furthermore, the interface to OSS/BSS is used in operation when the SO 100 is for example triggered by a service tool (network service orchestrator) to configure PSFs during a network deployment phase.

Another interface is the interface towards the NFV Orchestrator (NFVO) 160. This interface provides access to the virtualized part of the communication network. Basically, the interface towards the NFVO 160 has a similar relevance to the SO 100 as the interface towards OSS/BSS 150. For example, according to some examples of embodiments, during a deployment phase, the SO 100 is triggered by the NFV orchestrator 160 to configure the VSFs. Furthermore, according to some examples of embodiments, during a deployment phase, the SO 100 is triggered by the NFVO 160 to validate a security zone policy.

Another interface is the interface towards the VNF/VSF manager 170. This interface is used for procedures related to credential management and/or trust management. According to some examples of embodiments, this interface is also usable for other procedures and corresponding signaling, such as in connection with hardening and/or other management procedures.

A further interface is the interface towards the VIM 180. As described above, the VIM 180 provides a management access to security functions inside the NFV infrastructure, especially in the hypervisor 210. That is, besides the security functions running as VSFs on top of the hypervisor, the NFV infrastructure may provide also security functions like for example virtual firewalls. These security functions are accessible by the SO 100 by means of the interface between the SO 100 and VIM 180.

For executing the management tasks indicated above, several information elements are required by the SO 100. These information elements may be stored in or provided by storage portions as defined in the following.

In a security policy (SP) catalog, Security Policy Descriptors and Security Baseline Descriptors are stored, in addition to their reference guidelines, standards, procedures and pointers of security service descriptor.

In a security service (SS) catalog, security service descriptors, security function package (including VSFD and image, PSFD, etc.), and security rule descriptors are stored.

In a security policy (SP) instances repository, security policy records and security baseline records are stored, as well as their reference guidelines, standards, procedures and pointers of security service record. It is to be noted that an associated NS record (NSR) ID is included in the SPR/SBR.

Furthermore, a security service (SS) instances repository stores security service records, security function records (including VSFR and PSFR), and security rule records.

As indicated above, according to some examples of embodiments, the SO 100 conducts a mechanism to generate extended security zones allowing to increase the security of the communication network including virtualized network elements or functions and/or to adapt local and global requirements, such as legal, country-specific, operational (vendor separation, performance of security function) requirements. As one aspect according to examples of embodiments, VNFs are placed in security zones where physical and logical isolation is provided.

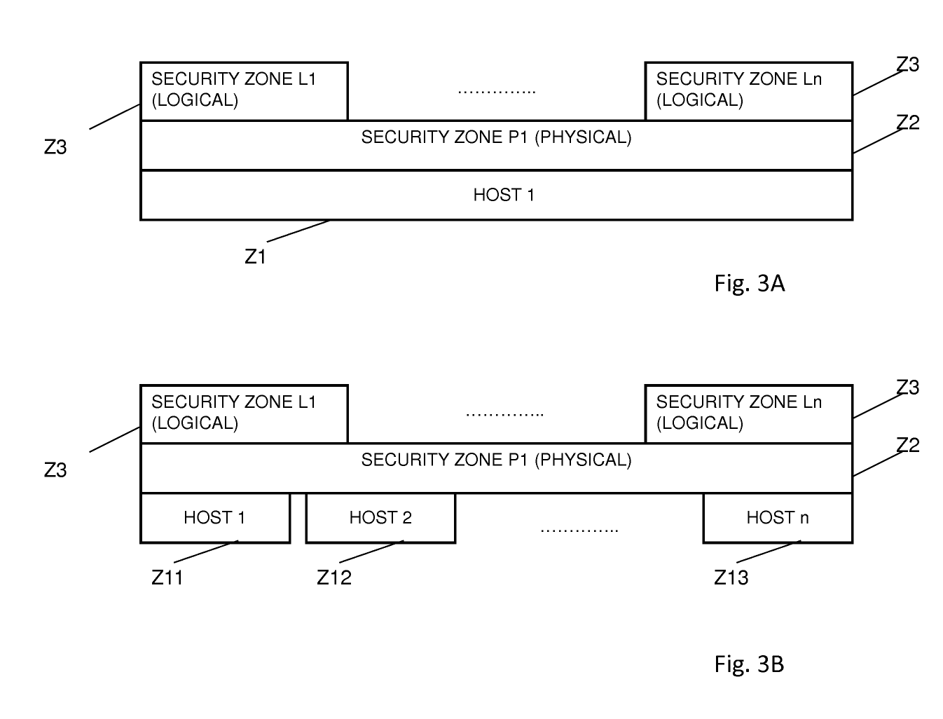

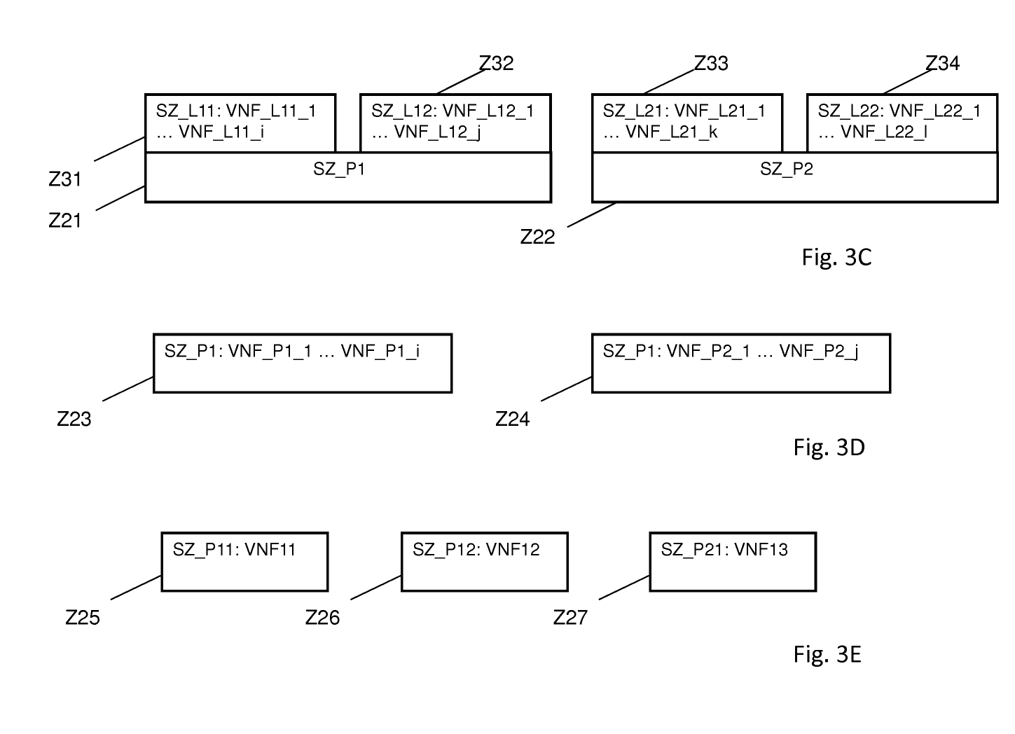

In the following, the general concepts for security zones according to examples of embodiments of the invention are explained, wherein corresponding illustrative examples are indicated in FIGS. 3A to 3E showing diagrams illustrating different examples of security zone configurations according to examples of embodiments.

A security zone in NFV is intended to segment CPU, memory, storage, network etc. for different type of VNFs according to security requirements of the NS/VNF. In this context, a physical separation is achieved by using separate physical zones in which a corresponding VNF is assigned to a different hardware (comprising one or more hosts, for example). A logical Separation is achieved by sharing a physical security zone (i.e. the corresponding hardware) between logical security zones. That is, a logical security zone is always built on a physical security zone or on a specific hardware element (e.g. in case only one hardware element is available for the specific segmentation). Furthermore, the logical security zone is not allowed to cross two or more physical security zones. Furthermore, a VNF can only be located in a single security zone.

A single security zone may comprise one or more hardware elements, such as one or more blades in the same datacenter. However, it is also possible that the security zone expands to a plurality of datacenters in different geography locations.

It is to be noted that according to examples of embodiments, for operation, both the NFV Orchestrator (NFVO) 160 and Security Orchestrator (SO) 100 have to be aware of the security zone concept.

FIG. 3A shows a first example of a security zone configuration according to examples of embodiments. Here, on a host HW Z1, a physical security zone (PSZ) P1 is established (indicated by reference sign Z2). Furthermore, a plurality of logical security zones Z3 (LSZ L1 to Ln) are provided in the PSZ P1.

FIG. 3b shows a second example of a security zone configuration according to examples of embodiments. Here, on a plurality of host HW Z11 to Z13, a physical security zone (PSZ) P1 is established (indicated by reference sign Z2). Furthermore, a plurality of logical security zones Z3 (LSZ L1 to Ln) are provided in the PSZ P1.

FIGS. 3C to 3E show further use cases of security zone configurations according to examples of embodiments. In FIG. 3C, the concept of physically segmentation plus logically segmentation is illustrated. There are two separated physical security zones (PSZ) P1 and P2 provided (indicated by reference signs Z21 and Z22, respectively), wherein two logical security zones Z31 and Z32 are provided to PSZ Z21. To LSZ Z31, VNF_L11_1 to VNF_L11_i are assigned, while to LSZ Z32, VNF_L12_1 to VNF_L12j are assigned. Similarly, with regard to the second PSZ Z22, two logical security zones Z33 and Z34 are provided, wherein to LSZ Z33, VNF_L21_1 to VNF_L21_k are assigned, while to LSZ Z34, VNF_L22_1 to VNF_L22_l are assigned.

In FIG. 3D, the concept of physically segmentation without logically segmentation is illustrated. Again, there are two separated physical security zones (PSZ) P1 and P2 provided (indicated by reference signs Z23 and Z24, respectively). To PSZ Z23, VNF_P1_1 to VNF_P1_i are assigned, while to PSZ Z34, VNF_P2_1 to VNF_P2_j are assigned.

In FIG. 3E shows a further concept of physically segmentation without logically segmentation. Here, each VNF is physically segmented to a different hardware (i.e. PSZ). That is, a VNF11 is assigned to PSZ P11 Z25, a VNF12 is assigned to PSZ P12 Z26, and a VNF13 is assigned to PSZ P13 Z27.

As indicated above, a further aspect of examples of embodiments is that, besides the separation into different security groups/zones as indicated by FIGS. 3A to 3E, for example, additional security attributes of different groups (i.e. resource-allocation-relevant and/or resource-allocation-independent) are considered for security zoning. This will be discussed in further detail below.

Generally, as described above, the security zone related functionality is provided by the SO. As a central security management node, the SO 100 has a holistic security view of the E2E service. Furthermore, security policies, which include security segmentation, localization requirement of the VNF, TMP requirement of VNF, etc, for the network service are aware by the SO 100.

For example, according to some examples of embodiments, the security zones are created depending on input information or configuration information. The configuration information includes, for example, at least one of VNF descriptors (VNFDs) and security zone profile information. In the VNFD, vendors can specify security related requirements or attributes, like for example the necessity for usage or support of security related hardware (TPM support to enable trusted boot or the provisioning of HW accelerators, e.g. for encryption purposes, etc). The security zone profile includes, for example, information provided by operators, like e.g. organization policies like vendor/tenant separation, special location of VNFs, legal requirements, inputs derived from standardization or regional regulation. According to examples of embodiments, the security zone profile may be provided by the network operator.

Depending on these two inputs, the SO 100 is configured to provide a proposal for a security zone configuration, i.e. a proposal for a network topology with a (first) security zoning suggestion. This proposal is presented, for example, on a suitable output device, such as a Graphical User Interface (GUI).

According to some examples of embodiments, the first proposal is mandatory, i.e. changes thereof are not possible, so that the further processing (provision of SZD described below) is based on this proposal. In this case, a formal description of the security zone configuration may be provided by the SO.

However, according to further examples of embodiments, it is also possible to allow an editing/refining processing. That is, the first proposal is a starting point for the operator to elaborate, for example, a refined or adapted security zone concept. This refinement may comprise, for example, creating/deleting of security zones in the security zone configuration proposal, assigning VNFs to/removing VNFs from security zones, assigning further security attributes to VNFs, etc. According to some further examples of embodiments, the SO provides means allowing the operator to overrule settings caused by the (initial) configuration information, e.g. to overrule VNFD-related vendor security requirements or the like. Thus, by means of a suitable output device like the GUI provided by the SO, the security zone design can be improved compared to a formal description.

Once the security zone design is finished (either by the SO alone or in connection with an editing process by the operator) and a final security zone configuration is presented, the SO 100 translates the result to the required information elements. That is, for example, when the security zone design with the VNFD and the security zone profile input for the NS is completed, the SO injects the required information into the NSD according to segmentation requirement and special security requirement like location, security related hardware (TPM etc.), etc. For example, according to some examples of embodiments, zero or more physical security zone descriptors (PSZD) are generated. In each PSZD, zero or more logical security zone descriptors (LSZD) are included. In each SZD, one or more member VNFD are included which have (VNFD related) security attributes. The security related attributes provide e.g. the resource-allocation-relevant information (like location, HW capabilities, Cloud type, a requirement to exclude a certain location or a specific setting for the VNF) and the resource allocation-independent information.

The information elements are then forwarded to the NFVO 160 which is responsible to establish the security zones in the NFV Infrastructure and to provide the requested resources.

FIG. 4 shows a flow chart illustrating a procedure for defining an extended security zone configuration according to some examples of embodiments. Specifically, FIG. 4 shows a processing by means of which security zones and related policies are designed.

In a first part, the SO selects the available input, for example on a corresponding user interface, such as a GUI, as described above. For this, in S10, input information comprising a default NSD and configuration information, i.e. constituted VNFDs, are received and processed.

Based on the input information, in S20, the SO begins to design a security zone policy.

Then, in S30, the SO selects another input, for example on a corresponding user interface such as a GUI, as described above. For this, in S30, input information comprising a security zone profile which is derived from standard, regional regulations, and organizations etc., is received and processed.

On the basis of the security zone profile and security requirements derived from the VNFD, in S40, the VNFs (indicated in the NSD) are segmented into at least one PSZ. Furthermore, in S50, the at least one PSZ is segmented into one or more LSZ according to the security zone profile and security requirements derived from the VNFD.

It is to be noted that depending on the available network resources, only a segmentation in LSZ is conducted, for example in case only one resource for the PSZ is available (i.e. when only one PSZ is possible at all). For the sake of simplicity, it is assumed in the following that both PSZ and LSZ can be configured.

In S60, the SZD is generated which includes the information for the PSZ and LSZ obtained in S40 and S50. In this context, it is to be noted that in case the possibility for editing/refining the default security zone concept is provided, S60 contains also procedures allowing an operator to further evaluate the security concept more fine-granularly on a user interface, e.g. the GUI and also overrule security zoning profile settings.

In S70, information for generating a new NSD with the SZD are provided. For example, the SO translates the final security zone concept into the corresponding IEs, e.g. the physical and logical SZD, and the security attributes. This information is then forwarded for preparing the NSD.

When the NS is deployed, the NFVO check the resource-allocation-relevant information, creates the security zones as described in the SZD and chooses the required resources for the VNFs as defined by the NSD Security Zone descriptors.

It is to be noted that, as a further option, according to some examples of embodiments, after the Management and Orchestration part (NFVO and VNFM, for example) has created the security zones and deployed VNFs in the security zones, the SO conducts a validation as to whether the creation and the deployment were done correctly (described in further detail below).

As indicated above, according to some examples of embodiments, it is proposed to support the establishment of security zones in the communication network by adding a corresponding information element (IE) in the NSD to assign VNFs to different security zones. According to some examples of embodiments, a corresponding IE is referred to as a security zone descriptor (SZD). In an ETSI NFV environment, this IE may have a cardinality of 0 . . . n, for example.

In the following, an example of a possible format of such information elements is indicated. For example, a NSD representing an information set for defining the deployment variant of a network service to be instantiated in a communication network is used as a basic information element and supplemented by an information element pszd as indicated in the following table 1.

TABLE 1

| Identifier | Type | Cardinality | Description |
|---|---|---|---|
| . . . | | | |
| pszd | Reference | 0 . . . N | Physical Security zone |
| | | | descriptor which used for |
| | | | physically isolation VNFs |
| . . . | | | |

The information element pszd as indicated in table 1 comprises, for example, the following information as indicated in table 2.

TABLE 2

| Identifier | Type | Cardinality | Description |
|---|---|---|---|
| id | Leaf | 1 | |
| name | Leaf | 1 | |
| type | Leaf | 1 | Represent physical zone |
| globalize | Leaf | 1 | Define whether the zone |
| | | | span across multiple |
| | | | DCs (potentially multiple |
| | | | geography location) |
| | | | 0: in a single DC |
| | | | 1: in multiple DC |
| . . . | | | |
| member vnfd | Element | 0 . . . N | VNFs in this physical |
| | | | security zone |
| . . . | | | |
| lszd | Reference | 0 . . . N | logical zones included in |
| | | | the physical zone |

The information element pszd:lszd as indicated in table 2 comprises, for example, the following information as indicated in table 3.

TABLE 3

| Identifier | Type | Cardinality | Description |
|---|---|---|---|
| id | Leaf | 1 | |
| name | Leaf | 1 | |
| type | Leaf | 1 | logical |
| parent zone | Reference | 1 | physical zone it's |
| | | | dependent on |
| globalize | Leaf | 1 | Define whether the zone |
| | | | span across multiple |
| | | | DCs (potentially multiple |
| | | | geography location) |
| | | | 0: in a single DC |
| | | | 1: in multiple DC |
| member vnfd | Element | 0 . . . N | VNFs in this logical |
| | | | security zone |
| . . . | | | |

The information element pszd:member vnf or pszd:lszd:member vnf as indicated in the table 3 comprises the following information as indicated in table 4.

TABLE 4

| Identifier | Type | Cardinality | Description |
|---|---|---|---|
| vnfd | Reference | 0 . . . N | VNFs in security zone |
| location | Leaf | 0 . . . N | 0 means no specific location |
| | | | requirement |
| cloud type | Leaf | 0 . . . 2 | 0: private 1: public 2: hybrid |
| tpm | Leaf | 0 . . . 1 | 0 means no specific TPM |
| | | | requirement, 1 means TPM |
| | | | requirement. |
| . . . | | | |

It is to be noted that the field tpm is only one example related to security related hardware setting, as described above, and can be replaced or extended by another suitable field, if required (i.e. in case other security related hardware is to be used instead of or in addition to a TPM).

Moreover, it is to be noted that according to some examples of embodiments, the VNFs of different NS are segmented in different physical security zones. Furthermore, in case the NSD received by the NFVO does not comprise a SZD, NFVO is completely free to choose the placement of the VNFs.

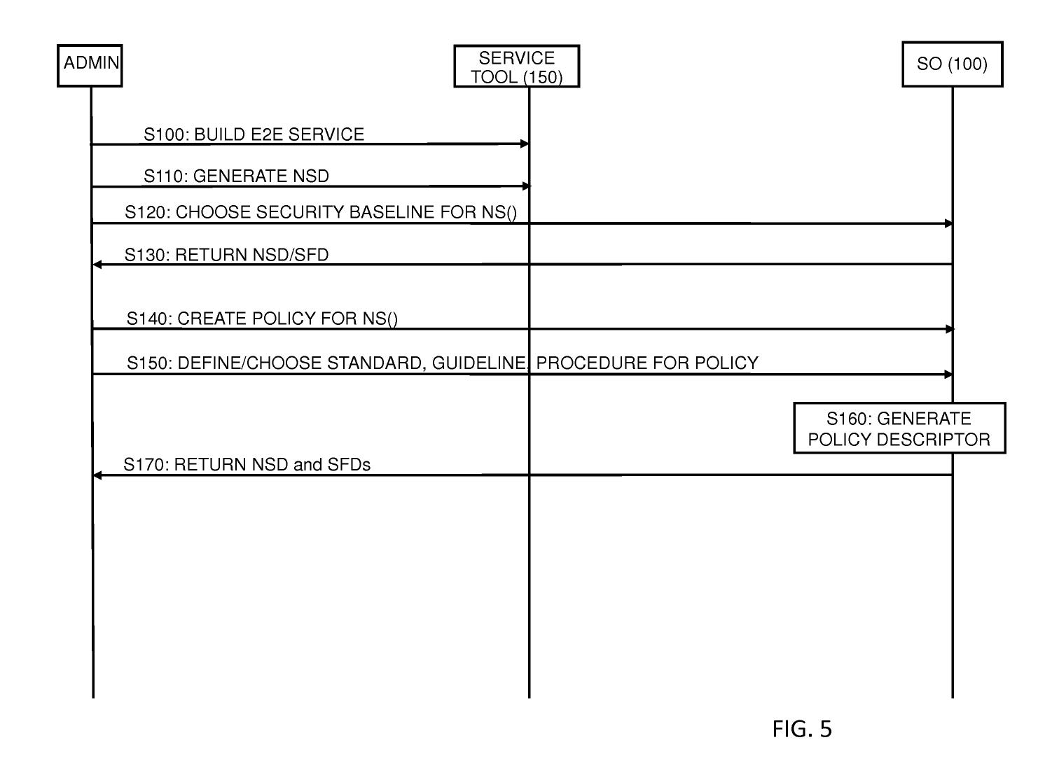

As indicated above, the interactions between the SO 100 and the connected management entities as shown in FIG. 2 are related to the automated deployment and configuration of a security service including at least one of PSF(s) and VSF(s). In FIG. 5, one type of interaction according to some examples of embodiments is described. Specifically, FIG. 5 shows a workflow diagram illustrating a processing for preparing and designing security according to some examples of embodiments.

As indicated in FIG. 5, there are two options for preparing an overall NSD including the whole network topology with security functions and SZD; it is to be noted that according to some further examples of embodiments also security function descriptors and their related security policies are provided in connection with security function related information. In these two options, one refers to a selection of a baseline for implementing security policy, while the other option refers to the creation of a new set of procedures for implementing security policy.

That is, in the examples of embodiments according to FIG. 5, the definition of security policy and its implementation for the network service is described, wherein it is assumed that a network administrator and a security administrator interact with the SO 100 and a service tool (provided e.g. by the OSS/BSS 150, e.g. Service Fulfillment, Network Engineering, or Service Orchestrator) to build a security template for the network service.

Specifically, as indicated in FIG. 5, in S100 and S110, the network administrator generates a NSD for a E2E service in cooperation with the service tool. Assuming now that the network administrator and the security administrator discuss which type of security policy is to be chosen for the network service. For example, in case the security baseline is chosen, in S120, the SO 100 is informed accordingly. As a response, in S130, the NSD and SFDs according to the baseline are sent to the administrator side.

On the other hand, in case it is chosen to create new security policy for the network service, in S140, an indication is sent to the SO 100 to create a policy for the network service. Furthermore, in S150, it is signaled to the SO 100 which standard, guideline and procedure for the policy are to be defined or chosen.

In S160, the SO 100 generates or obtains a corresponding policy descriptor (for example from a predefined information being stored in advance). For example, the SPD refers to standard, guideline and procedure for its implementation (see also FIG. 3). The security service and related configuration rules are included in the policy as well.

In S170, a corresponding NSD and SFDs are returned to the administrator side. That is, information about a reference VSF is returned.

It is to be noted that the above described alternatives (baseline and new policy) can be either chosen separately or in a combined manner, i.e. both can be considered for selection.

Regarding the security zoning procedure as described in connection with FIG. 4, a corresponding processing may be implemented in connection with S120/S130 or S160/S170, for example.

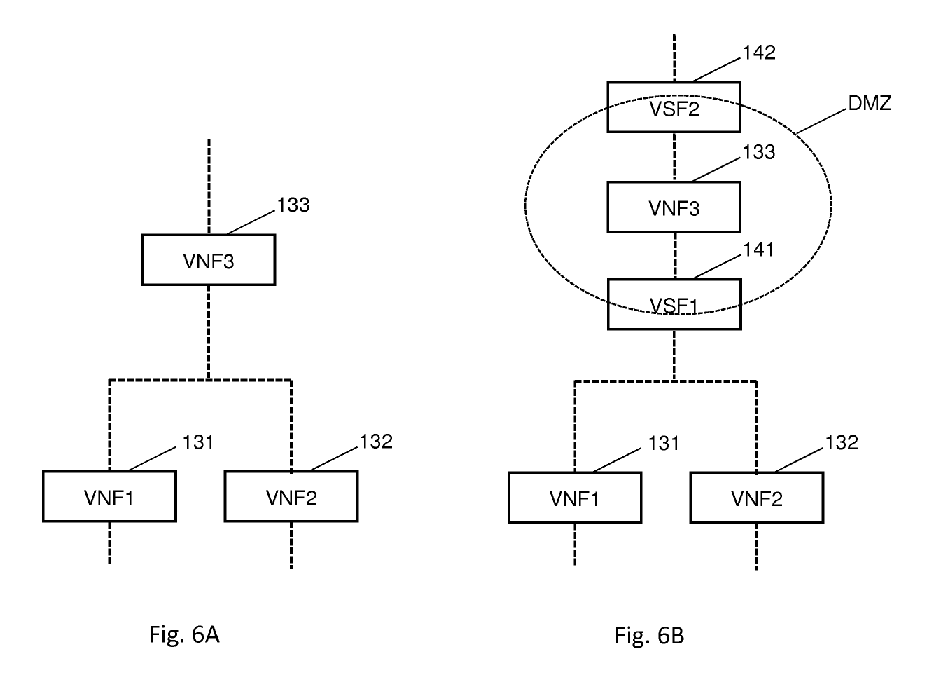

FIGS. 6A/B show diagrams illustrating a result of security policy definition according to some examples of embodiments. Specifically, FIGS. 6A/B illustrate results of a security policy definition according to the processing indicated in FIG. 5.

FIG. 6A illustrates, for example, a part of a network configuration according to a starting point, i.e. before the security policy is defined. The topology in FIG. 6A is formed by three VNFs, i.e. VNF1 131, VNF2 132, VNF3 133, which form any part of a hybrid network. VNF1 131, VNF2 132, VNF3 133 are contained in the original NSD in S110 of FIG. 5, for example.

FIG. 6B illustrates the same part of the network configuration like FIG. 6A, but after the processing for defining the security policy. The topology in FIG. 6B is formed by the three VNFs, i.e. VNF1 131, VNF2 132, VNF3 133, and two VSFs VSF1 141 and VSF2 142 (for example firewalls). This topology formed by the three VNFs plus the two VSFs is returned in the NSD in S130 or S170 by the SO 100. Thus, for example, DMZ is formed around the VNF3 133.

It is to be noted that the SO 100 provides also the related security policies. Hence, the SO 100 makes it possible not only to enforce the security functions, but also enforce the related security policies on the network service via configuring rules on the security functions.

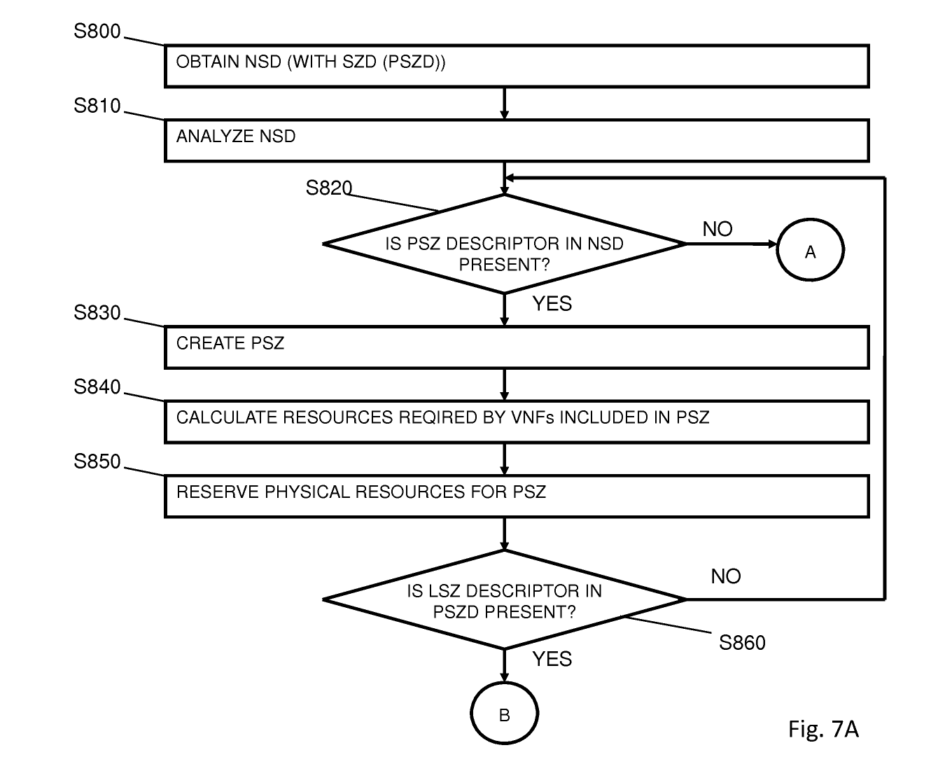

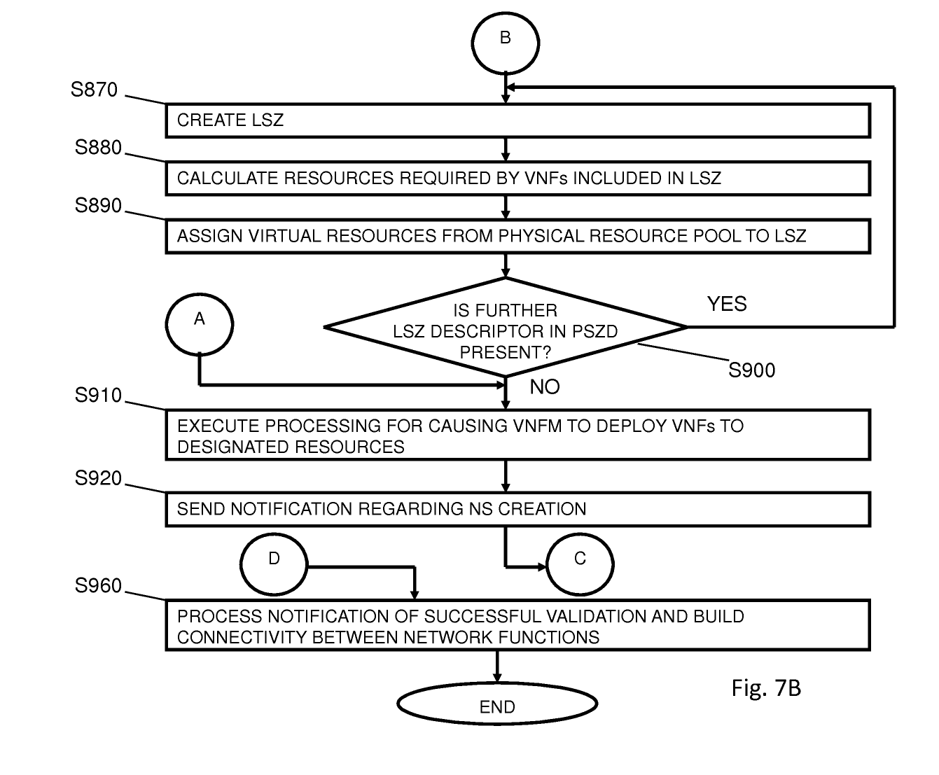

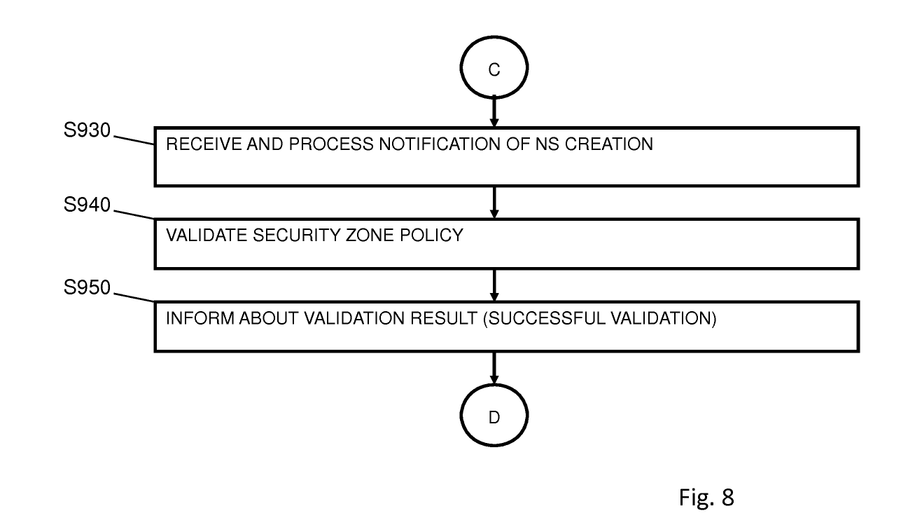

With regard to FIGS. 7A, 7B and 8, a procedure for deploying security zone policy for a network service according to some examples of embodiments is described with regard to the establishment of security zones and a deployment of VNFs in a related security zone, wherein also a validation procedure for validating a security zone policy for a network service by the SO is considered. Specifically, FIGS. 7A and 7B are related to a processing conducted by the NFVO 160 for enforcing a security zone policy in the NS/VNF during an initial NS deployment, while FIG. 8 is related to a processing in the SO 100 for validation according to some examples of embodiments.

Basically, the processing described in connection with FIGS. 7A, 7B and 8 is related to the processing conducted when the preparation phase illustrated in FIG. 4 is finished. That is, a new NSD containing all information being necessary to build the extended security zones is available and transferred to the NFVO 160 for conducting an automated deployment and configuration processing. Here, the NFVO (in cooperation with the VNFM) establishes the extended security zone concept as described by the SZD in the new NSD. Furthermore, according to some examples of embodiments, once the automated deployment and configuration is finished, the SO 100 is contacted in order to validate whether the extended security zone concept was successfully established.

When starting the default deployment flow, in S800, the NSD including the SZD as described above is obtained by the NFVO. Then, the security zone policy on the NS/VNF during NS default deployment is enforced. For this purpose, the NSD is analyzed or parsed in S810 in order to determine whether a PSZD is part of the NSD (i.e. SZD) in S820.

In case the PSZD is not detected in S820, the processing proceeds to S910 (described later).

Otherwise, in case the PSZD is detected in S820, the processing proceeds to S830. Here, the PSZ is created. For this purpose, in S840, the resources required by at least one VNF included in the PSZ are calculated, and in S850, corresponding (physical) resources are reserved in the communication network.

Then in S860, it is checked whether (for the current PSZ) any LSZD are present in the PSZD.

In case no LSZD is detected, the processing returns to S820 in order to determine whether further PSZD are part of the NSD (here, in case no further PSZD is detected in the next processing of S820, the processing proceeds to S910 (described later).

On the other hand, in case an LSZD is detected in S860, the processing proceeds to S870.

In S870 (see FIG. 7B), the LSZ is created. For this purpose, in S880, the resources required by at least one VNF included in the LSZ are calculated, and in S890, corresponding virtual resources are assigned from the physical resource pool to the LSZ.

Then, in S900, it is checked whether any further LSZD is present in the PSZD. In case a further LSZD is detected, the processing returns to S870. Otherwise, in case no further LSZD is detected, the processing proceeds to S910.

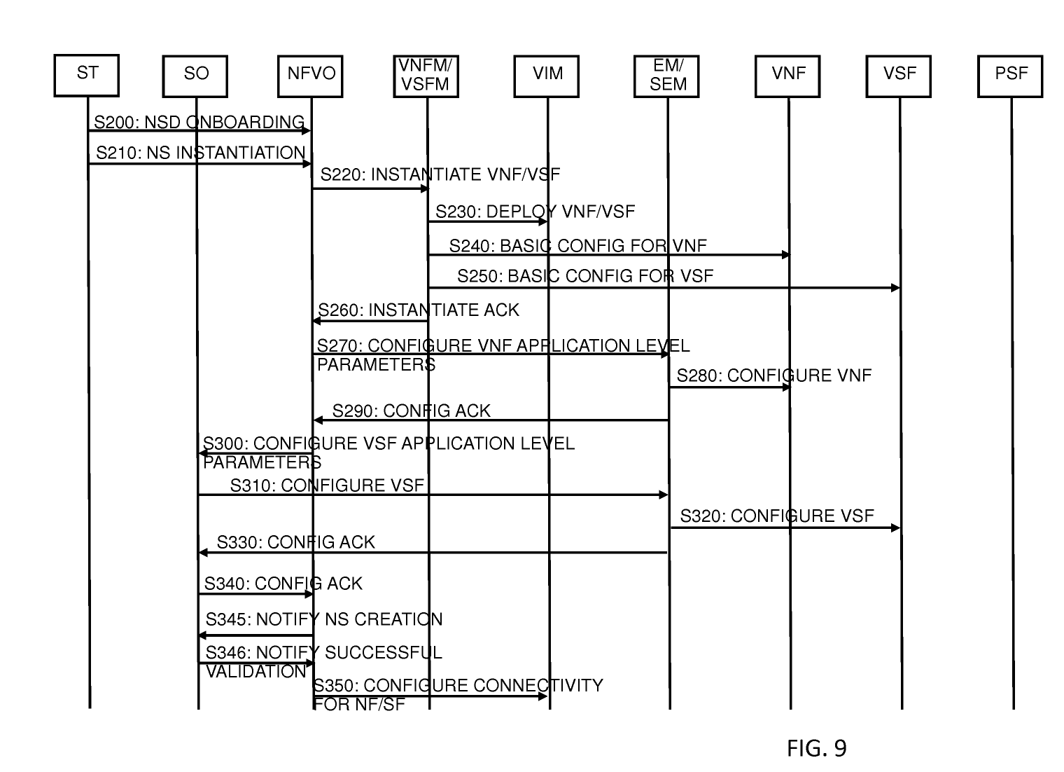

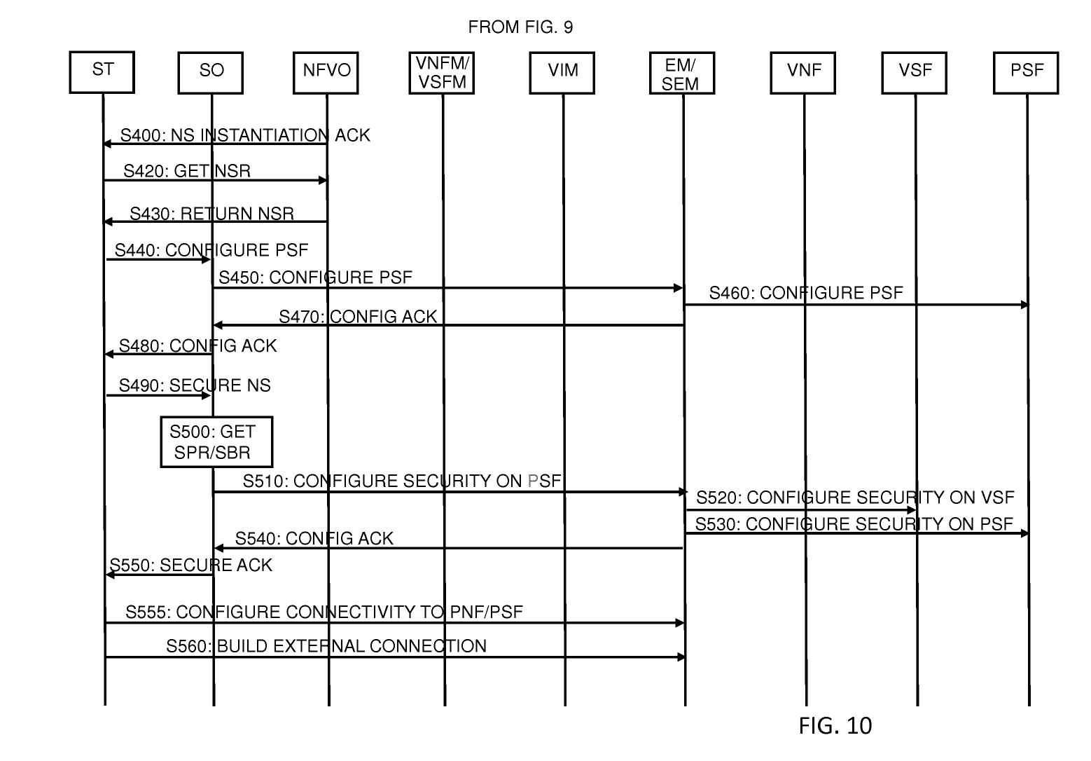

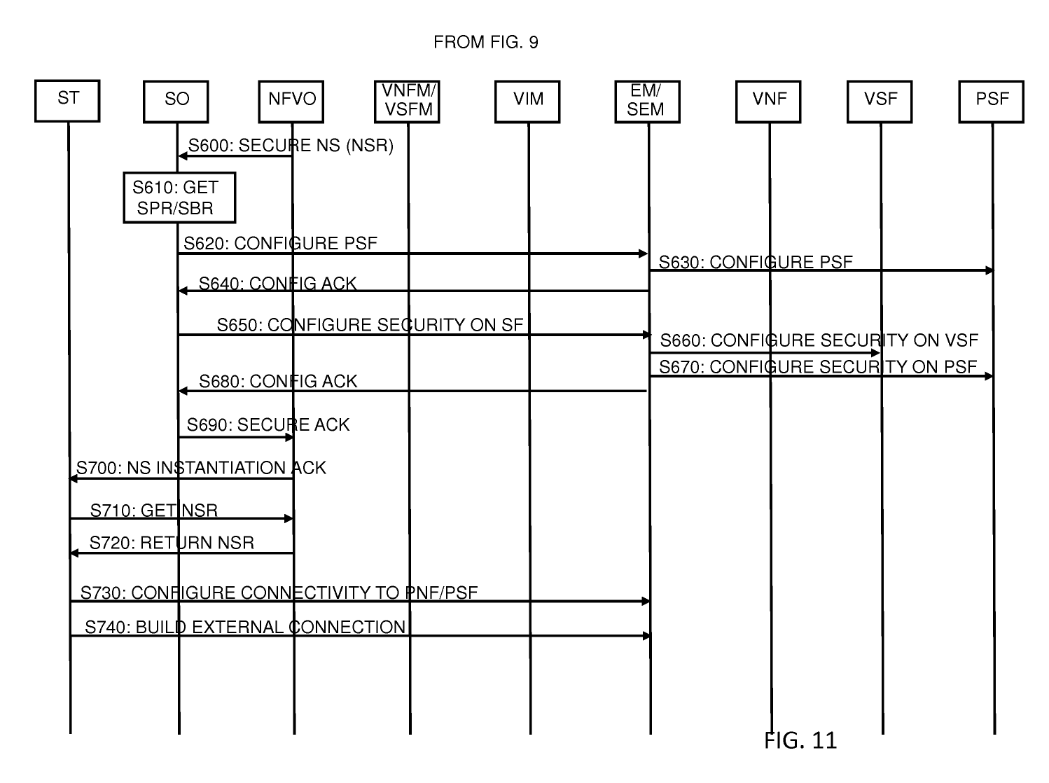

In S910, a processing for causing the VNFM to deploy VNFs to the designated resources is conducted, i.e. NS is created considering the settings for the security zones. A corresponding processing is described, for example, in connection with FIGS. 9 to 11 discussed below.

In S920, when the NS creation is completed, a notification is sent to the SO informing about the creation for triggering a validation procedure in the SO. An example for such a validation processing is shown in FIG. 8.

Here, in S930, the SO receives and processes the notification of the NS creation. Then, e.g. by means of an interaction with the MANO, in S940, it is validated whether the security zone policy is fulfilled. The result of the validation, in particular a result indicating a successful validation, is then transmitted to the NFVO in S950.

Back to FIG. 7B, in S960, the result of the validation processing in the SO is received and processed. Based on the successful validation, the connectivity between the network functions of the NS is built. Then, the processing ends.

As described above, according to some examples of embodiments, the security zone policy is enforced on the NS/VNF during the NS initial deployment. In case of NS scaling, VNF scaling or VNF moving, according to some examples of embodiments, the respective VNF is always deployed in the same security zone like that being selected in the initial deployment.

In the following, implementation examples of the automated deployment and configuration of PSFs and VSFs are described in connection with FIGS. 9 and 10 or FIGS. 9 and 11. Specifically, the combination of FIGS. 9 and 10 describes a first option for the automated deployment and configuration of PSFs and VSFs, while the combination of FIGS. 9 and 11 describes a second option for the automated deployment and configuration of PSFs and VSFs.

It is to be noted that for illustrative purposes the following examples are related to examples of embodiments of the invention in which the provisioning of automated E2E security for a hybrid network is integrated in ETSI NFV MANO workflows.

With regard to the workflow indicated in FIG. 9, which shows a workflow diagram illustrating a first part of a processing for deploying network security according to some examples of embodiments, it is assumed that a security policy and its implementation (and/or a security baseline) has been defined for a E2E service, wherein a NSD with security information was generated (e.g. according to examples of embodiments as indicated in FIG. 5).

First, in S200, NSD onboarding (together with VNF/VSF onboarding) is conducted between the service tool and the NVFO, and in S210, the NS instantiation is executed between the service tool and the NVFO. Thus, the service tool has triggered the instantiation of the NS by means of the NSD which includes security functions in its topology description.

Next, the NFVO and the VNFM follow defined procedures to instantiate the VNFs/VSFs and to connect them to a network service according to the NSD (without knowing about the security functionality of the VSFs), wherein the VSFs are configured via the security orchestrator. In detail, in S220, the NFVO sends to the VNFM an indication to instantiate the VNF(s) and VSF(s), as long as they are not already existent. It is to be noted that the processing described in connection with FIGS. 7A and 7B may be executed here.

In S230, the VNFM informs the VIM to deploy the VNF/VSF in question. Furthermore, in S240 and S250, the VNFM conducts a basic configuration for the VNF and VSF, respectively.

After that, in S260, the VNFM acknowledges the instantiation to the NFVO.

In S270, the NFVO send a message to the EM to configure the VNF application level parameters. The EM configures the VNF accordingly in S280. Then, in S290, the configuration is acknowledged to the NFVO.

In S300, the NFVO sends a message to the SO to configure the VSF application level parameters. The SO sends in S310 a corresponding configuration message to the SEM, which configures the VSF accordingly in S320 (alternatively, the SO can configure the VSF directly). Then, in S330, the configuration is acknowledged to the SO and in S340 to the NFVO.

It is to be noted that the processing according to S220 to S340 is to be executed for each VNF/VSF instantiated in the hybrid network even though FIG. 9 shows only one VNF and VSF.

In S345 and S346, a signaling related to a validation procedure as described above in connection with FIGS. 7B and 8 (S920 to S960) is executed.

In S350, the NFVO configures connectivity for both VNFs and VSFs based on the network topology description at the VIM.

Next, with regard to the workflow indicated in FIG. 10, a workflow diagram is described which illustrates a second part of a processing for deploying network security according to some examples of embodiments, wherein the above defined first option is concerned.

After S350 of FIG. 9, in S400, the NFVO acknowledges the NS instantiation to the service tool.

In S420, the service tool signals to the NFVO in order to get the NSR. The NFVO returns the NSR to the service tool in S430.

In S440, the service tool triggers the SO to configure the PSF(s). It is to be noted that although the term ‘physical security function’ conveys a rather static impression, PSFs themselves may be virtualized as well and may therefore need configuration as well.

The SO informs the SEM in S450 to configure the PSF, and the SEM conducts configuration of the PSF(s) in S460 (alternatively, the SO can configure the PSF directly).

In S470, the configuration of the PSF(s) is acknowledged by the SEM to the SO, which in turns sends in S480 an acknowledgement to the service tool.

After the NSD with security functions is thus deployed, next, according to examples of embodiments implementing the above mentioned first option, the service tool triggers the SO to secure the network service. Specifically, in S490, the service tool sends a trigger to the SO to conduct a processing for securing the NS.

In S500, the SO instantiates and gets the SPR (and/or SBR) from storage and configures security on the security service/functions. That is, the security orchestrator gets the security functions and security rules from the security policy/baseline record and continues to enforce the security on the security functions. For this purpose, the SO informs in S510 the SEM accordingly, and the SEM configures the security on the VSF in S520 and on the PSF in S530. It is to be noted that in the example according to FIG. 10, the configuration is again conducted via the EM, but as indicated above, the SO can also directly control the SFs (PSF/VSF).

In S540, the configuration is acknowledged by the EM to the SO, which in turn sends an acknowledgement to the service tool in S550.

The service tool, in S555, can now configure connectivity to the PNF(s)/PSF(s) via the EM/SEM. It is to be noted that S410 can be omitted in case all connectivities are already built in S350, for example.

In S560, the service tool builds an external connection via the EM, that is, it connects the service e.g. to the Internet after the security for the service is enforced.

Now, with regard to the workflow indicated in FIG. 11, a workflow diagram is described which illustrates a second part of a processing for deploying network security according to some examples of embodiments, wherein the above defined second option is concerned.

While the first option described in connection with FIG. 9 enables, for example, an administrator at the service tool to have generally more influence on the automatism, e.g. by interrupting the workflow after S480 and restarting it with S490 when he has verified that the envisaged security of the network service meets his expectations, the second option described with the workflow according to FIG. 11 provides a more automated flow with less involvement of the service tool.

After S350 of FIG. 9, in S600, the NFVO triggers the SO to secure the network service. Specifically, in S490, the service tool sends a trigger to the SO to conduct a processing for securing the NS wherein the signaling includes also the NSR.

In S610, the SO instantiates and gets the SPR (and/or SBR) from storage and configures security on the security service/functions. That is, the security orchestrator gets the security functions and security rules from the security policy/baseline record and continues to enforce the security on the security functions.

For this purpose, the SO informs the SEM in S620 to configure the PSF, and the SEM conducts configuration of the PSF(s) in S630 (alternatively, the SO can configure the PSF directly). In S640, the configuration of the PSF(s) is acknowledged by the SEM to the SO (comparable to S450 to S470 in FIG. 10).

Then, the SO informs in S620 the SEM to configure security on the SFs, and the SEM configures the security on the VSF in S660 and on the PSF in S670. It is to be noted that in the example according to FIG. 11, the configuration is again conducted via the SEM, but as indicated above, the SO can also directly control the SFs (PSF/VSF).

In S680, the SEM acknowledges the configuration to the SO, and in S690, the SO acknowledges to the NFVO that the security is completed.

In S700, the NFVO acknowledges the NS instantiation to the service tool.

The service tool, in S710, signals to the NFVO in order to get the NSR. The NFVO returns the NSR to the service tool in S720.

In S730, the service tool can now configure connectivity to the PNF(s)/PSF(s) via the EM/SEM. It is to be noted that according to some examples of embodiments S730 can be omitted in case all connectivities are already built in S350 of FIG. 9, for example.

In S740, the service tool builds an external connection via the EM, that is, it connects the service e.g. to the Internet after the security for the service is enforced.

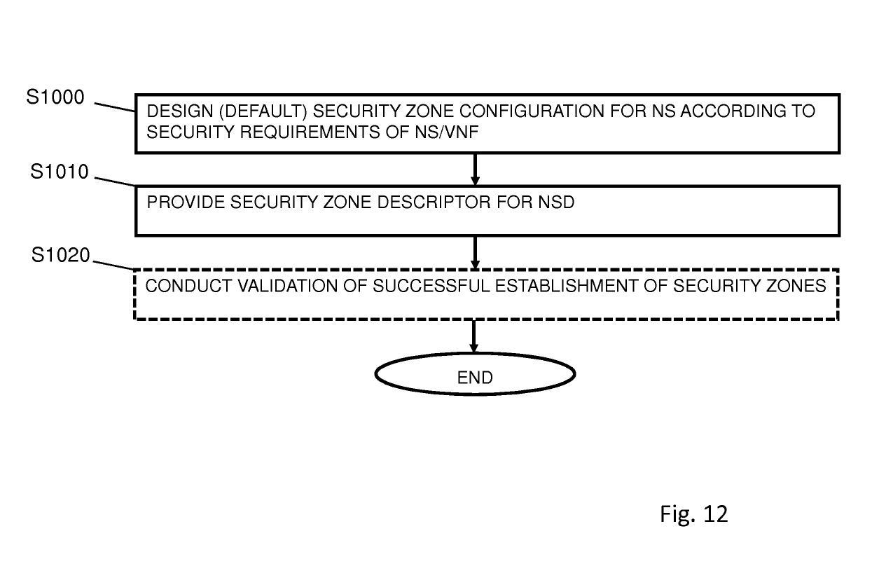

FIG. 12 shows a flow chart of a processing for managing and orchestrating security in a communication network according to some examples of embodiments. Specifically, the example according to FIG. 12 is related to a procedure conducted by a security orchestrator element or function managing security in the communication network, such as the management entity or function 100 in the architecture as depicted e.g. in FIG. 2.

In S1000, an (initial or default) extended security zone configuration for a network service to be instantiated including at least one VNF in a communication network comprising virtualized network parts is designed. According to examples of embodiments, the extended security zone configuration assigns the at least one VNF according to at least one of local and global security requirements to at least one dedicated security zone (the dedicated security zone is a physical security zone to which the at least one VNF is assigned, or a logical security zone inside a physical security zone to which the at least one VNF is assigned).

According to some examples of embodiments, configuration information and a default information set defining a deployment variant of the network service to be instantiated (i.e. NSD) are acquired and a security zone policy using the configuration information is defined. The at least one VNF is assigned to at least one of a physical security zone and a logical security zone, wherein the physical security zone is set on a at least one dedicated host hardware of the communication network, and the logical security zone is set on one physical security zone. Furthermore, security attributes for the at least one VNF are determined.

Moreover, according to some examples of embodiments, the configuration information includes at least one of a VNFD information indicating security related requirements and a security zone profile information indicating organization policies according, wherein the at least one VNF is assigned to at least one of the physical security zone and the logical security zone by segmenting the at least one VNF at least one of the physical security zone and the logical security zone on the basis of the VNFD information and the security zone profile information. According to some examples of embodiments, the VNFD information defines vendor-specific security related requirements including a requirement for support of security related hardware etc., and the security zone profile information defines security zone related policies based on at least one of organization policies, standards, regional regulations, legal requirements and includes at least one of a vendor separation indication, a tenant separation indication, and redundancy information.

According to some examples of embodiments, an editing procedure for altering and refining a design result of a default security zone configuration according to a user input is conducted in connection with S1000. The editing procedure is conducted by using a user interface or the like, such as a GUI, a text based editing tool, a script based editing tool, etc., and provides the ability to overrule settings provided by configuration information used in the design of the default extended security zone configuration.

In S1010, a security zone descriptor (SZD, such as the PSZD) information element describing a final result of the extended security zone configuration design is provided for usage in an information set defining a deployment variant of the network service to be instantiated (i.e. NSD).

According to some examples of embodiments, for providing the security zone descriptor information element describing the final result of the extended security zone configuration design for usage in the information set defining the deployment variant of the network service to be instantiated, at least one of a physical security zone descriptor indicating an assignment of the at least one virtual network element to a physical security zone, a logical security zone descriptor indicating an assignment of the at least one virtual network function to a logical security zone, and a security attribute information according to the final extended security zone configuration is generated. For example, the security attribute information includes at least one of resource allocation relevant attributes indicating at least one of a location of a hardware of the communication network where the at least one VNF is to be instantiated, an exclusion of a specified location or setting for the at least one VNF, a capability of a hardware of the communication network where the at least one VNF is to be instantiated, a type of a cloud where the at least one VNF is to be instantiated, and a requirement for security related hardware (such as TPM), and resource allocation independent attributes indicating at least one of a requirement for vendor separation, a requirement for tenant separation, and a redundancy requirement.

According to some examples of embodiments, a successful establishment of security zones in the communication network is validated after providing the security zone descriptor information element describing the final result of the extended security zone configuration design. This is indicated by S1020. For example, an information indicating the creation of the network service to be instantiated is received, it is validated that a security zone policy is fulfilled in the creation of the network service for validating a successful establishment of security zones in the communication network, and a result of the validation is notified.

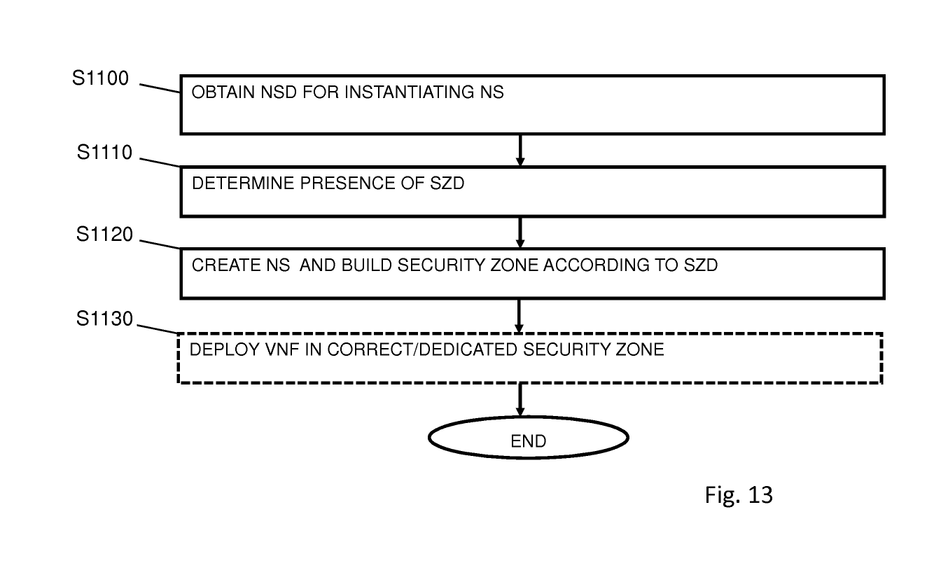

FIG. 13 shows a flow chart of a processing related to the managing and orchestrating of security in a communication network according to some examples of embodiments. Specifically, the example according to FIG. 12 is related to a procedure conducted by a NFV orchestrator element or function managing network function virtualization in the communication network, such as the management entity or function 160 in the architecture as depicted e.g. in FIG. 2.

In S1100, an information set defining a deployment variant of a network service to be instantiated in a communication network comprising virtualized network parts (i.e. an NSD) is obtained. The network service includes at least one VNF.

In S1110, it is determined whether the information set includes a security zone descriptor information element describing an extended security zone configuration assigning the at least one VNF according to local and/or global security requirements to at least one dedicated security zone.

In S1120, the network service is created in the communication network according to the information set wherein the at least one dedicated security zone is built by selecting required resources in the communication network according to information of the security zone descriptor information element.

According to some examples of embodiments, as indicated by S1130, the VNF is deployed in the correct/dedicated security zone, i.e. the at least one dedicated security zone is built by deploying and configuring the at least one VNF according to information of the security zone descriptor information element by using a VNFM element or function in the communication network.

Furthermore, according to some examples of embodiments, the dedicated security zone comprises at least one of a physical security zone and a logical security zone to which the at least one VNF is assigned, wherein the physical security zone is set on a at least one dedicated host hardware of the communication network, and the logical security zone is set on one physical security zone.

In addition, according to some examples of embodiments, the security zone descriptor information element describing the extended security zone configuration includes at least one of a physical security zone descriptor indicating an assignment of the at least one virtual network element to a physical security zone, a logical security zone descriptor indicating an assignment of the at least one virtual network function to a logical security zone, and a security attribute information according to the final extended security zone configuration. Furthermore, the security attribute information includes at least one of resource allocation relevant attributes indicating at least one of a location of a hardware of the communication network where the at least one VNF is to be instantiated, an exclusion of a specified location or setting for the at least one VNF, a capability of a hardware of the communication network where the at least one VNF is to be instantiated, a type of a cloud where the at least one VNF is to be instantiated, and a requirement for security related hardware (such as TPM etc.), and resource allocation independent attributes indicating at least one of a requirement for vendor separation, a requirement for tenant separation, and redundancy requirement.

According to some examples of embodiments, a procedure for a validation of a successful establishment of security zones in the communication network is conducted after creating the network service. Then, in case the successful establishment of the security zones is validated, connectivity in the network service is built. For example, for validating the successful establishment of the security zones, an information indicating the creation of the network service to be instantiated is provided to a security orchestrator element or function. When receiving, in response thereof, an information indicating a result of a validation that a security zone policy is fulfilled in the creation of the network service for validating a successful establishment of security zones in the communication network, the connectivity is built.

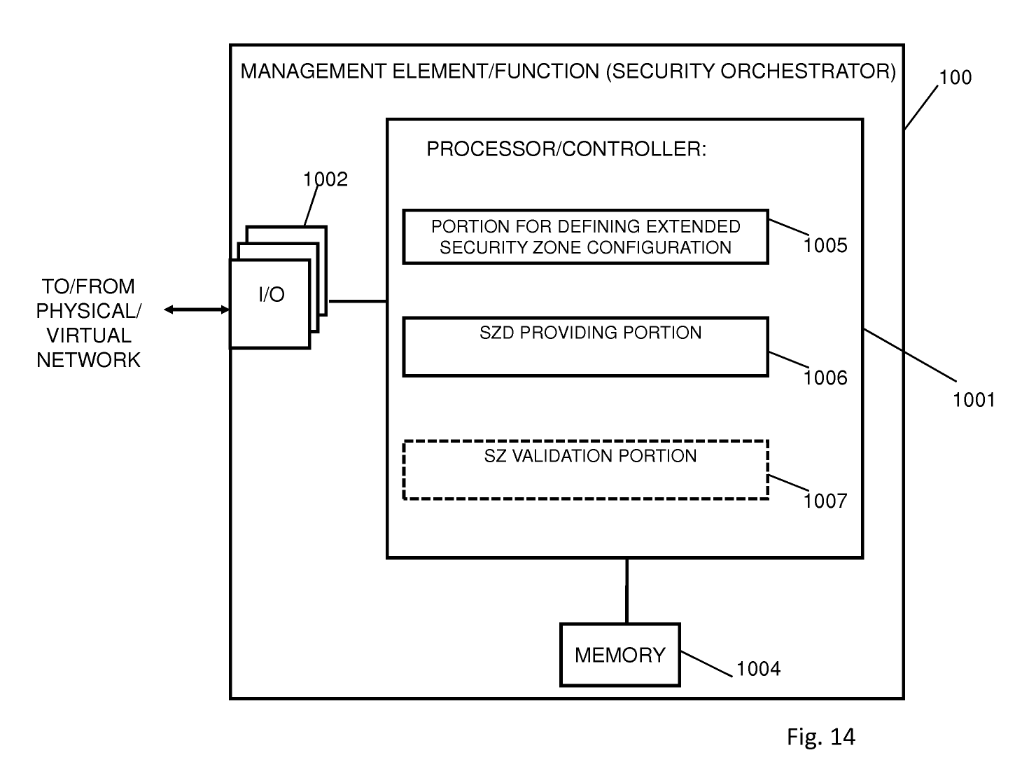

FIG. 14 shows a diagram of a network element like a managing entity serving as the SO according to some examples of embodiments, which is configured to implement a procedure for managing security in a communication network as described in connection with some of the examples of embodiments. It is to be noted that the network element, like the managing entity or function 100 of FIG. 2, which is configured to act as a SO, may include further elements or functions besides those described herein below. Furthermore, even though reference is made to a network element, management entity or function, the element, entity or function may be also another device or function having a similar task, such as a chipset, a chip, a module, an application etc., which can also be part of a network element or attached as a separate element to a network element, or the like. It should be understood that each block and any combination thereof may be implemented by various means or their combinations, such as hardware, software, firmware, one or more processors and/or circuitry.

The management entity or function shown in FIG. 14 may include a processing circuitry, a processing function, a control unit or a processor 1001, such as a CPU or the like, which is suitable for executing instructions given by programs or the like related to the control procedure. The processor 1001 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference sign 1002 denotes input/output (I/O) units or functions (interfaces) connected to the processor or processing function 1001. The I/O units 1002 may be used for communicating with other management entities or functions, as described in connection with FIG. 2, for example, such as the OSS/BSS 150, the NFVO 160, the VIM 180, PSF/VSF and the like. The I/O units 1002 may be a combined unit including communication equipment towards several management entities, or may include a distributed structure with a plurality of different interfaces for different entities. Reference sign 1004 denotes a memory usable, for example, for storing data and programs to be executed by the processor or processing function 1001 and/or as a working storage of the processor or processing function 1001. It is to be noted that the memory 1004 may be implemented by using one or more memory portions of the same or different type of memory.

The processor or processing function 1001 is configured to execute processing related to the above described security procedure. In particular, the processor or processing circuitry or function 1001 includes one or more of the following sub-portions. Sub-portion 1005 is a processing portion which is usable as a portion for defining an extended security zone configuration. The portion 1005 may be configured to perform processing according to S1000 of FIG. 12. Furthermore, the processor or processing circuitry or function 1001 may include a sub-portion 1006 usable as a portion for providing the SZD information. The portion 1006 may be configured to perform a processing according to S1010 of FIG. 12. In addition, the processor or processing circuitry or function 1001 may include (optionally) a sub-portion 1007 usable as a portion for validating the SZ. The portion 1007 may be configured to perform a processing according to S1020 of FIG. 12.

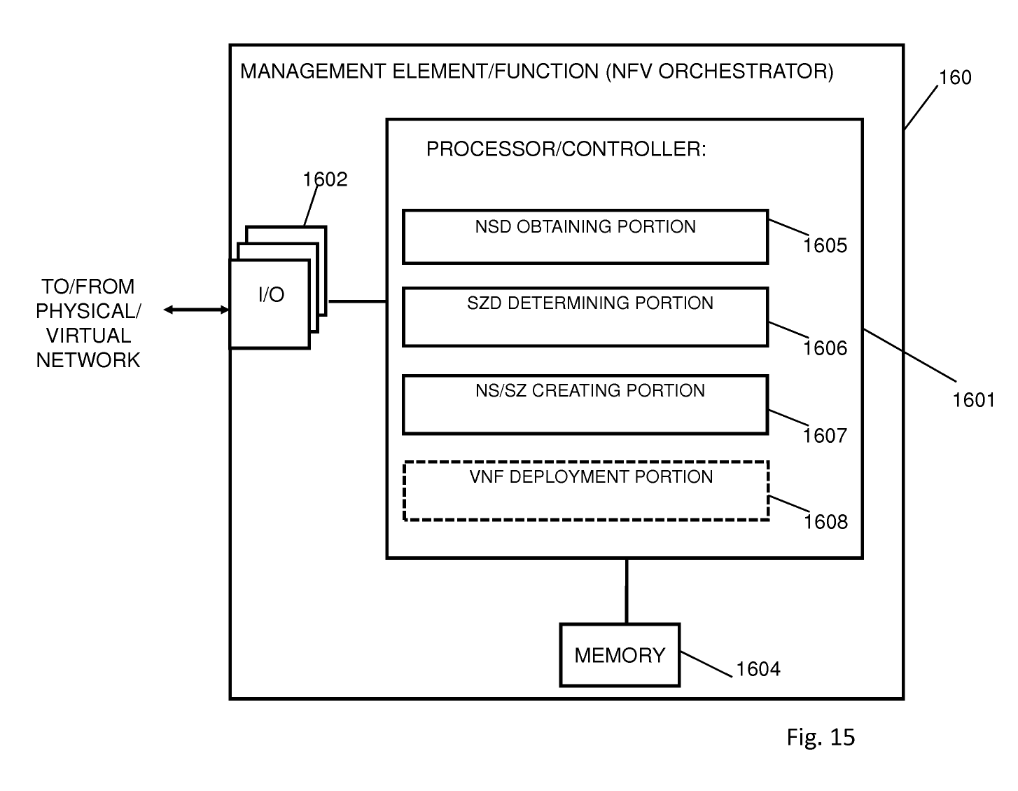

FIG. 15 shows a diagram of a network element like a managing entity serving as the NFVO according to some examples of embodiments, which is configured to implement a procedure related to managing security in a communication network as described in connection with some of the examples of embodiments. It is to be noted that the network element, like the managing entity or function 160 of FIG. 2, which is configured to act as a NFVO, may include further elements or functions besides those described herein below. Furthermore, even though reference is made to a network element, management entity or function, the element, entity or function may be also another device or function having a similar task, such as a chipset, a chip, a module, an application etc., which can also be part of a network element or attached as a separate element to a network element, or the like. It should be understood that each block and any combination thereof may be implemented by various means or their combinations, such as hardware, software, firmware, one or more processors and/or circuitry.

The management entity or function shown in FIG. 15 may include a processing circuitry, a processing function, a control unit or a processor 1601, such as a CPU or the like, which is suitable for executing instructions given by programs or the like related to the control procedure. The processor 1061 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference sign 1602 denotes input/output (I/O) units or functions (interfaces) connected to the processor or processing function 1601. The I/O units 1602 may be used for communicating with other management entities or functions, as described in connection with FIG. 2, for example, such as the SO 100, the VIM 180 and the like. The I/O units 1602 may be a combined unit including communication equipment towards several management entities, or may include a distributed structure with a plurality of different interfaces for different entities. Reference sign 1604 denotes a memory usable, for example, for storing data and programs to be executed by the processor or processing function 1601 and/or as a working storage of the processor or processing function 1601. It is to be noted that the memory 1604 may be implemented by using one or more memory portions of the same or different type of memory.

The processor or processing function 1601 is configured to execute processing related to the above described procedures. In particular, the processor or processing circuitry or function 1601 includes one or more of the following sub-portions. Sub-portion 1605 is a processing portion which is usable as a NSD obtaining portion. The portion 1605 may be configured to perform processing according to S1100 of FIG. 13. Furthermore, the processor or processing circuitry or function 1601 may include a sub-portion 1606 usable as a portion for determining an SZD (PSZD/LSZD) in the NSD. The portion 1606 may be configured to perform a processing according to S1110 of FIG. 13. In addition, the processor or processing circuitry or function 1601 may include a sub-portion 1607 usable as a portion for creating the network service and the security zones. The portion 1607 may be configured to perform a processing according to S1120 of FIG. 13. Furthermore, the processor or processing circuitry or function 1601 may include (optionally) a sub-portion 1608 usable as a portion for deploying the VNF in the SZ. The portion 1608 may be configured to perform a processing according to S1130 of FIG. 13.

As described above, according to examples of embodiments, for managing security in a hybrid communication network, a management entity or function referred to as security orchestrator is provided. For example, according to examples of embodiments, the SO is implemented as SW package structured according to the described tasks and with the defined interfaces. The SW performing the SO tasks can be implemented according to the workflow diagrams described above.

That is, according to some examples of embodiments, a mechanism is proposed allowing a holistic end-to-end security view in a communication network (e.g. in accordance with an ETSI NFV environment) and enabling the generation of dedicated security zones. Furthermore, an automated deployment as well as an automated configuration/management of PSFs and VSFs is possible. Thus, a flexible and automated end-to-end security for communication networks implemented e.g. at least in part in a telecommunication cloud is achievable. Consequently, a flexible and automated solution for network security in telecommunication cloud solutions (e.g. in an ETSI NFV environment) can be provided. Thus, by means of the proposed automated security management of hybrid networks, which includes also physical network parts, cloud-based advantages of flexibility and automation can be maintained.

By means of the extended security zone concept described above, it is possible that the VNF security in cloud environments is significantly improved by segmenting virtualized telecommunication networks into zones, i.e. extended security zones providing required capabilities (i.e., meeting security relevant requirements or location constraints). As security zoning is combined with other security and security-related attributes, it provides a comprehensive security concept that enables operators to fine-granularly control security in a telecommunication cloud (like ETSI NFV) environment. Furthermore, the ETSI NFV IEs can be extended in a way that all relevant information is provided centralized and consistently, especially for the NFV Orchestrator who is in the end responsible to realize the extended security zone concept.

In addition, according to another example of embodiments, there is provided an apparatus comprising means for designing an extended security zone configuration for a network service to be instantiated including at least one virtual network function in a communication network comprising virtualized network parts, wherein the extended security zone configuration assigns the at least one virtual network function according to at least one of local and global security requirements to at least one dedicated security zone, and means for providing a security zone descriptor information element describing a final result of the extended security zone configuration design for usage in an information set defining a deployment variant of the network service to be instantiated.

Furthermore, according to some other examples of embodiments, the above defined apparatus may further comprise means for conducting at least one of the processing defined in the above described methods, for example a method according that described in connection with FIG. 12.

Moreover, according to another example of embodiments, there is provided an apparatus comprising means for obtaining an information set defining a deployment variant of a network service to be instantiated in a communication network comprising virtualized network parts, the network service including at least one virtual network function, means for determining whether the information set includes a security zone descriptor information element describing an extended security zone configuration assigning the at least one virtual network function according to at least one of local and global security requirements to at least one dedicated security zone, and means for creating the network service in the communication network according to the information set wherein the at least one dedicated security zone is built by selecting required resources in the communication network according to information of the security zone descriptor information element.

Furthermore, according to some other examples of embodiments, the above defined apparatus may further comprise means for conducting at least one of the processing defined in the above described methods, for example a method according that described in connection with FIG. 13.

It should be appreciated that
an access technology via which traffic is transferred to and from an entity in the hybrid communication network may be any suitable present or future technology, such as WLAN (Wireless Local Access Network), WiMAX (Worldwide Interoperability for Microwave Access), LTE, LTE-A, Bluetooth, Infrared, and the like may be used; additionally, embodiments may also apply wired technologies, e.g. IP based access technologies like cable networks or fixed lines.
embodiments suitable to be implemented as software code or portions of it and being run using a processor or processing function are software code independent and can be specified using any known or future developed programming language, such as a high-level programming language, such as objective-C, C, C++, C#, Java, Python, Javascript, other scripting languages etc., or a low-level programming language, such as a machine language, or an assembler.
implementation of embodiments is hardware independent and may be implemented using any known or future developed hardware technology or any hybrids of these, such as a microprocessor or CPU (Central Processing Unit), MOS (Metal Oxide Semiconductor), CMOS (Complementary MOS), BiMOS (Bipolar MOS), BiCMOS (Bipolar CMOS), ECL (Emitter Coupled Logic), and/or TTL (Transistor-Transistor Logic).
embodiments may be implemented as individual devices, apparatuses, units, means or functions, or in a distributed fashion, for example, one or more processors or processing functions may be used or shared in the processing, or one or more processing sections or processing portions may be used and shared in the processing, wherein one physical processor or more than one physical processor may be used for implementing one or more processing portions dedicated to specific processing as described,
an apparatus may be implemented by a semiconductor chip, a chipset, or a (hardware) module including such chip or chipset;
embodiments may also be implemented as any combination of hardware and software, such as ASIC (Application Specific IC (Integrated Circuit)) components, FPGA (Field-programmable Gate Arrays) or CPLD (Complex Programmable Logic Device) components or DSP (Digital Signal Processor) components.
embodiments may also be implemented as computer program products, including a computer usable medium having a computer readable program code embodied therein, the computer readable program code adapted to execute a process as described in embodiments, wherein the computer usable medium may be a non-transitory medium.

Although the present invention has been described herein before with reference to particular embodiments thereof, the present invention is not limited thereto and various modifications can be made thereto.

1. An apparatus, comprising:
at least one processing circuitry;
and
at least one memory for storing instructions to be executed by the processing circuitry, wherein
the at least one memory and the instructions are configured to, with the at least one processing circuitry, cause the apparatus at least to:
design an extended security zone configuration for a network service to be instantiated including at least one virtual network function in a communication network comprising virtualized network parts, wherein the extended security zone configuration assigns the at least one virtual network function according to at least one of local and global security requirements to at least one dedicated security zone, and
provide a security zone descriptor information element describing a final result of the extended security zone configuration design for usage in an information set defining a deployment variant of the network service to be instantiated.

2. The apparatus according to claim 1, wherein the at least one memory and the instructions are further configured to, with the at least one processing circuitry, cause the apparatus at least to:
acquire configuration information and a default information set defining a deployment variant of the network service to be instantiated,
define a security zone policy using the configuration information,
assign the at least one virtual network function to at least one of a physical security zone and a logical security zone, wherein the physical security zone is set on a at least one dedicated host hardware of the communication network, and the logical security zone is set on one physical security zone, and
determine security attributes for the at least one virtual network function.

3. The apparatus according to claim 2, wherein the configuration information includes at least one of a virtual network function descriptor information indicating security related requirements and a security zone profile information indicating organization policies, wherein the at least one virtual network function is assigned to at least one of the physical security zone and the logical security zone by segmenting the at least one virtual network function to at least one of the physical security zone and the logical security zone on the basis of the virtual network function descriptor information and the security zone profile information.

4. The apparatus according to claim 3, wherein
the virtual network function descriptor information defines vendor-specific security related requirements including a requirement for support of security related hardware, and
the security zone profile information defines security zone related policies based on at least one of organization policies, standards, regional regulations, legal requirements, and includes at least one of a vendor separation indication, a tenant separation indication, and redundancy information.

5. The apparatus according to claim 1, wherein the at least one memory and the instructions are further configured to, with the at least one processing circuitry, cause the apparatus at least to:
conduct an editing procedure for altering and refining a design result of a default extended security zone configuration according to a user input,
wherein the editing procedure is conducted by using a user interface including at least one of a graphical user interface, a text based editing tool and a script based editing tool, and provides the ability to overrule settings provided by configuration information used in the design of the default extended security zone configuration.

6. The apparatus according to claim 1, wherein the at least one memory and the instructions are further configured to, with the at least one processing circuitry, cause the apparatus at least to:
generate, for providing the security zone descriptor information element describing the final result of the extended security zone configuration design for usage in the information set defining the deployment variant of the network service to be instantiated, at least one of a physical security zone descriptor indicating an assignment of the at least one virtual network element to a physical security zone, a logical security zone descriptor indicating an assignment of the at least one virtual network function to a logical security zone, and a security attribute information according to the final extended security zone configuration.

7. The apparatus according to claim 6, wherein the security attribute information includes at least one of
resource allocation relevant attributes indicating at least one of a location of a hardware of the communication network where the at least one virtual network function is to be instantiated, an exclusion of a specified location or setting for the at least one virtual network function to be instantiated, a capability of a hardware of the communication network where the at least one virtual network function is to be instantiated, a type of a cloud where the at least one virtual network function is to be instantiated, and a requirement for a security related hardware, and
resource allocation independent attributes indicating at least one of a requirement for vendor separation, a requirement for tenant separation, and a redundancy requirement.

8. The apparatus according to claim 1, wherein the at least one memory and the instructions are further configured to, with the at least one processing circuitry, cause the apparatus at least to:
validate a successful establishment of security zones in the communication network after providing the security zone descriptor information element describing the final result of the extended security zone configuration design.

9. The apparatus according to claim 8, wherein the at least one memory and the instructions are further configured to, with the at least one processing circuitry, cause the apparatus at least to:
receive an information indicating the creation of the network service to be instantiated,
validate that a security zone policy is fulfilled in the creation of the network service for validating a successful establishment of security zones in the communication network, and
inform about a result of the validation.

10. The apparatus according to claim 1, wherein the information set defining the deployment variant of the network service to be instantiated is a network service descriptor.

11. The apparatus according to claim 1, wherein the apparatus is implemented in a security orchestrator element or function managing security in the communication network.

12.-22. (canceled)

23. An apparatus, comprising:
at least one processing circuitry;
and
at least one memory for storing instructions to be executed by the processing circuitry, wherein
the at least one memory and the instructions are configured to, with the at least one processing circuitry, cause the apparatus at least to:
obtain an information set defining a deployment variant of a network service to be instantiated in a communication network comprising virtualized network parts, the network service including at least one virtual network function,
determine whether the information set includes a security zone descriptor information element describing an extended security zone configuration assigning the at least one virtual network function according to at least one of global and local security requirements to at least one dedicated security zone, and
create the network service in the communication network according to the information set wherein the at least one dedicated security zone is built by selecting required resources in the communication network according to information of the security zone descriptor information element.

24. The apparatus according to claim 23, wherein the at least one memory and the instructions are further configured to, with the at least one processing circuitry, cause the apparatus at least:
to build the at least one dedicated security zone by deploying and configuring the at least one virtual network function according to information of the security zone descriptor information element by using a virtual network function managing element or function in the communication network.

25. The apparatus according to claim 23, wherein the dedicated security zone comprises at least one of a physical security zone and a logical security zone to which the at least one virtual network function is assigned, wherein the physical security zone is set on at least one dedicated host hardware of the communication network, and the logical security zone is set on one physical security zone.

26. The apparatus according to claim 23, wherein the security zone descriptor information element describing the extended security zone configuration includes at least one of a physical security zone descriptor indicating an assignment of the at least one virtual network element to a physical security zone, a logical security zone descriptor indicating an assignment of the at least one virtual network function to a logical security zone, and a security attribute information according to the final extended security zone configuration.

27. The apparatus according to claim 26, wherein the security attribute information includes at least one of
resource allocation relevant attributes indicating at least one of a location of a hardware of the communication network where the at least one virtual network function is to be instantiated, an exclusion of a specified location or setting for the at least one virtual network function to be instantiated, a capability of a hardware of the communication network where the at least one virtual network function is to be instantiated, a type of a cloud where the at least one virtual network function is to be instantiated, and a requirement for a security related hardware, and
resource allocation independent attributes indicating at least one of a requirement for vendor separation, a requirement for tenant separation, and a redundancy requirement.

28. The apparatus according to claim 23, wherein the at least one memory and the instructions are further configured to, with the at least one processing circuitry, cause the apparatus at least to:
conduct a procedure for a validation of a successful establishment of security zones in the communication network after creating the network service, and
build, in case the successful establishment of the security zones is validated, connectivity in the network service.

29. The apparatus according to claim 28, wherein the at least one memory and the instructions are further configured to, with the at least one processing circuitry, cause the apparatus at least to:
provide an information indicating the creation of the network service to be instantiated,
receive an information indicating a result of a validation that a security zone policy is fulfilled in the creation of the network service for validating a successful establishment of security zones in the communication network.

30. The apparatus according to claim 23, wherein the information set defining the deployment variant of the network service to be instantiated is a network service descriptor.

31. The apparatus according to claim 23, wherein the apparatus is implemented in a network function virtualization orchestrator element or function managing virtualized network parts in the communication network.

32.-40. (canceled)

41. A computer program product embodied on a non-transitory computer-readable medium having a computer readable program code embodied therein, the computer readable program code adapted to execute a process comprising:
designing an extended security zone configuration for a network service to be instantiated including at least one virtual network function in a communication network comprising virtualized network parts, wherein the extended security zone configuration assigns the at least one virtual network function according to at least one of local and global security requirements to at least one dedicated security zone, and
providing a security zone descriptor information element describing a final result of the extended security zone configuration design for usage in an information set defining a deployment variant of the network service to be instantiated.

42. A computer program product embodied on a non-transitory computer-readable medium having a computer readable program code embodied therein, the computer readable program code adapted to execute a process comprising:
obtaining an information set defining a deployment variant of a network service to be instantiated in a communication network comprising virtualized network parts, the network service including at least one virtual network function,
determining whether the information set includes a security zone descriptor information element describing an extended security zone configuration assigning the at least one virtual network function according to at least one of local and global security requirements to at least one dedicated security zone, and
creating the network service in the communication network according to the information set wherein the at least one dedicated security zone is built by selecting required resources in the communication network according to information of the security zone descriptor information element.

43. (canceled)

44. (canceled)
